(19) United States
(12) Patent Application Publication
(10) Pub. No.: US 2025/0181064 A1
(43) Pub. Date: Jun. 5, 2025

(54) KPI CURVE DATA PROCESSING METHOD

(71) Applicant: THREE GORGES INTELLIGENT INDUSTRIAL CONTROL TECHNOLOGY CO., LTD., Wuhan (CN)

(72) Inventors: Xi DAI, Wuhan (CN); Xuchao XU, Wuhan (CN); Zhongliang LIAO, Wuhan (CN); Chong XU, Wuhan (CN); Xuan CENG, Wuhan (CN); Xuxin YUE, Wuhan (CN); Qing ZHANG, Wuhan (CN); Lichao YIN, Wuhan (CN)

(73) Assignee: THREE GORGES INTELLIGENT INDUSTRIAL CONTROL TECHNOLOGY CO., LTD., Wuhan, HB (CN)

(21) Appl. No.: 18/845,002

(22) PCT Filed: Mar. 17, 2023
(86) PCT No.: PCT/CN2023/082359

§ 371 Date: Sep. 9, 2024

(30) Foreign Application Priority Data
Mar. 18, 2022 (CN) 202210270544.4
Mar. 24, 2022 (CN) 202210292597.6
Mar. 24, 2022 (CN) 202210292660.6
Mar. 24, 2022 (CN) 202210292662.5

(51) Int. Cl. G05B 23/02

(52) U.S. Cl. CPC G05B 23/0227; G05B 23/0264; G05B 23/0281

(57) ABSTRACT

A KPI curve data processing method is disclosed, involving the following steps: segmenting a KPI curve into several equal-length wavebands, clustering these wavebands based on a non-time dimension, and extracting a fundamental wave for each cluster. The method compares the similarity between each waveband's data and the fundamental wave of its cluster, identifies the cluster's grouping boundary, and groups the wavebands accordingly. It calculates the total time length of consecutive wavebands of the same type in each cluster, using the maximum length as the width of a sliding window. Scanning the KPI curve with this window allows consecutive clusters to be quickly grouped into a single waveform category, reducing computation and enabling integral classification of the wavebands. This process forms distinct waveband chains, aiding in clustering and classification, while minimizing knowledge omission

### FIELD OF THE INVENTION

The present invention relates to the technical field of artificial intelligence, and relates to a method for setting a width of a sliding window for scanning a KPI curve, which belongs to the technical field of marking and data processing of a periodic law of a KPI curve. The present invention also relates to marking characteristics of wavebands of a KPI curve, marking the KPI curve according to a period and a waveband type of the KPI curve based on an image processing technology, and correlating different KPI curves of a same system according to output results.

### BACKGROUND OF THE INVENTION

Monitoring indicators in an industrial control system are monitored in real time, so that KPI curves of different monitoring indicators can be extracted. These KPI indicators are all periodic, and some monitoring indicators are also correlated, thus being correlatively influenced according to a period. In order to explore a correlation of these indicators, it is necessary to classify various wavebands in a KPI curve into different fundamental wave types, and it is necessary to slidably scan the KPI curve by a sliding window during the classification. In one method, the sliding window is set to have a time length of 1 s, the KPI curve is segmented into several segments with the length of 1 s, and corresponding different types of fundamental waves also have the time length of 1 s. As a result, waveform segments used for recognition, comparison and marking are too short, which can directly increase a calculation amount of a label in the later stage exponentially. Meanwhile, transient noise in information may also be introduced into a knowledge system of later calculation as a fundamental wave type to extract a large number of irrelevant interference items, so that a lot of specific object knowledge is captured while reducing the accuracy of system output, leading to the reduction of universality of a model, which is not conducive to migration and adjustment works in future. In addition, continuous waveform segments cannot be jointly used as one fundamental wave type to directly classify the KPIs, leading to the lack of pattern recognition of a whole waveband in the KPI curve in extracted information and the omission of knowledge.

In another method, the sliding window is set to have a time length of 1 period, but there may be many short different fundamental wave types in one period. When the wavebands are clustered and grouped in each window, a plurality of clusters are formed, and a plurality of fundamental waves are formed in each window, so that the calculation amount can be increased exponentially. Meanwhile, due to the large calculation amount, when the model is used in the later stage, corresponding time from data generation to system alarm can be prolonged. Therefore, a new method is needed to set the sliding window for scanning the KPI curve.

A method for real-time anomaly detection by setting a threshold for KPI data is very common. However, the threshold setting depends on user experience, and meanwhile, with the gradual increase of the KPI data, a method of configuring several thresholds for each KPI data may consume huge manpower. Therefore, the anomaly detection of the KPI data should aim at avoidance of threshold setting and high automation.

Time sequence decomposition is a method for exploring a change law of a time sequence, which mainly explores periodicity and tendency. Time sequence decomposition algorithms based on period and trend decomposition mainly comprise a classical time sequence decomposition algorithm, a Holt-Winters algorithm and an STL algorithm.

Traditional time sequence prediction methods often aim at the modeling of one-dimensional time sequence itself, and it is difficult to use additional characteristics. In contrast, a method based on a neural network may often achieve better detection results. For example, in a Donut method using a variational automatic encoder (VAE), a single time sequence is modeled (trained), and data with a large reestablishment error are judged as abnormal data; and in DeepAR, probability distribution of a value of a sequence on each time step may be used to effectively learn a global model from relevant time sequences, thus learning a complex mode. In addition, there are also some supervised anomaly detection methods, in which marked sample data may be used for model training, so that the methods also usually achieve very good detection results.

In practical work, there are many monitoring indicators and many types of anomalies. There are many time sequence data analysis algorithms, which often have unclear applicable scenarios, and people often do not know which algorithm and parameter should be used. In addition, there may be deficiencies in data, and improper processing will lead to low accuracy of anomaly detection.

Traditional machine learning is mainly classified into supervised learning and unsupervised learning, which are distinguished by whether a data level has a label. In recent years, in order to reduce costs, a method with minimum manpower input is developed and called a weak supervision model, which can reduce the use of manual labeling as much as possible, and mainly has three types of incomplete supervision, inexact supervision and inaccurate supervision for application scenarios of for partial data labeling, coarse granularity labeling and mixed fault labeling respectively.

In order to pursue effectiveness, traditional machine learning mostly adopts the supervised learning. In practice, it is difficult to obtain anomaly labeling in batches, and the accuracy of model output is improved through a large number of labeled data samples. Therefore, a large number of business experts are needed to manually label the KPI curve, which often requires repeated adjustment and correction, thus being time-consuming and labor-consuming. Actually, it may be necessary to start to monitor millions and tens of millions of KPIs at the same time. Therefore, in practice of actual anomaly detection, it is often impossible to discover a certain algorithm capable of meeting the above requirements, and it is impossible to solve the above challenges at the same time. However, clustering and other technologies are commonly used in the unsupervised learning and are mainly used for characteristic discovery, data exploration and other scenarios. Because of the lack of labeling, the results need to be interpreted by data scientists to be abstractly mapped to a business model instead of being directly used. In specific realization of weak monitoring, because of staged introduction of unsupervised/supervised methods, circularly recursive accuracy improvement and excessive technicality, the weak monitoring is difficult to be practiced. On the other hand, for integration in specific methods, vector expression is needed to unify expressions of different methods, and the results are not easy for uses to understand.

When there are more data, business scenarios are more complex, introduction methods are more complex, and more diversified costs/manpower are required. Therefore, there is the classic saying that “there is as much intelligence as there is manpower” for the practice of a machine learning industry. This cycle directly limits the promotion of machine learning in all industries, and the machine learning is mainly applied in industries with higher returns, so that conventional industries give up resistance, defend passively, and rely on compensation by an average level of all industries to realize business scenario migration. Specifically, if one method is particularly effective in other industries, after there are abundant staffs, an observation effect is borrowed, and the method is considered to be used in the case of being feasible. The industrial application scenario is one of such passive defense industries.

The method for real-time anomaly detection by setting the threshold for the KPI data is very common, but a method for real-time anomaly detection for a system log has not been publicly reported.

### SUMMARY OF THE INVENTION

A first object of the present invention is to provide a KPI curve data processing method, in which a width of a sliding window for scanning a KPI curve is set, and steps comprise: segmenting a KPI curve into several wavebands of equal length, clustering the wavebands to form a plurality of clusters according to a non-time dimension of the wavebands, extracting a fundamental wave of each cluster, comparing a similarity between data of each waveband and the fundamental wave of each cluster, discovering a grouping boundary line of each cluster, grouping the data of each waveband of each cluster, extracting a total time length of consecutive wavebands of the same type in each cluster, and taking a maximum value of the total time length as a width of a sliding window. The window is used for segmenting the KPI curve, so that the wavebands in each window after segmentation are easy to be clustered and classified, thus being conducive to quickly forming a waveband chain composed of different types of wavebands for the whole KPI curve in a single window. A waveband chain corresponding to each window has its own characteristics, thus facilitating clustering and classification on the basis of the waveband chains.

The technical scheme adopted in the present invention is as follows: a KPI curve data processing method, comprising the following steps of:
Step 1: establishing a waveform according to a relationship between historical data and time of monitoring indicators in a same system to obtain a KPI curve of at least one monitoring indicator, wherein each monitoring indicator is one attribute of a data point of the KPI curve, and the same system refers to a material production process, an energy production process or a control system consisting of monitored objects with direct or indirect material supply relationship, electric energy transfer relationship, thermal energy transfer relationship, mechanical energy transfer relationship, magnetic field transfer relationship, energy conversion relationship or signal control relationship; and the monitoring indicators are physical parameters acquired by sensors on the monitored objects;
Step 2: segmenting the KPI curve into several wavebands with a time sequence width of 1 s, clustering the wavebands to form a plurality of clusters according to a non-time dimension of the wavebands, and extracting a fundamental wave of each cluster;
Step 3: comparing a similarity between data of each waveband and the fundamental wave of each cluster in the Step 2, discovering a grouping boundary line of each cluster, and grouping the data of each waveband of each cluster;
Step 4: extracting a time stamp of each cluster classified into different groups to obtain a time stamp list of each group;
Step 5: carrying out shift subtraction on the time stamp list of each group, which refers to subtracting a starting time stamp of the next item from a starting time stamp of the current item in each time stamp list to obtain an event trigger interval list;
Step 6: merging event trigger intervals of each cluster into a time interval KPI set, and calculating a similarity between the time interval KPI sets of various clusters according to NCC;
Step 7: expanding the similarity between the time interval KPI sets of various clusters obtained in the Step 4 to form a similarity matrix;
Step 8: sequencing the similarity between the time interval KPI sets of various clusters according to a numerical value, then fitting the numerical value of the similarity into a smooth line, and obtaining a boundary line of the similarity between the time interval KPI sets of various clusters according to an inflection point method;
Step 9: marking adjacent clusters with numerical values greater than an inflection point in the similarity matrix as a same similar group, and counting a number of clusters in each similar group; and
Step 10: calculating a total time interval of one group with a largest number of clusters in the similar groups as a width of a sliding window.

The waveform in Step 1 is filtered and forms a KPI curve of at least one monitoring indicator.

Preferably, in the Step 2, the step of extracting the fundamental wave of each cluster comprises: calculating an arithmetic mean value ΣFⱼ/j of a data set of a j segment of the KPI curve in data sets of each group as the fundamental wave of the group.

Preferably, the Step 2 comprises the following steps of: Step J2: extracting a data point set of each time sequence in all KPI curves processed in the Step 1 into a same curve set L, setting a stride sliding window, with a step length of s, wherein s=1 second, and segmenting the curve set L into data sets Mᵢ of several segments of the KPI curve with a time width of s according to a window width, wherein i is a segment sequence number;
Step J3: calculating an Euclidean distance between data sets of various segments according to an attribute of the data set of each segment of the KPI curve by a dbscan algorithm, and clustering a data set of an i segment of the KPI curve to obtain k cluster categories and abnormal items, wherein each cluster is data sets of one group, and the data sets of each group contain the data set Fⱼ of the j segment of the KPI curve; and
Step J4: calculating the arithmetic mean value ΣFⱼ/j of the data set of the j segment of the KPI curve in the data sets of each group as the fundamental wave of the group;
the Step 3 comprises the following steps of:
Step J5: calculating a waveform similarity between the data set Fⱼ of each segment of the KPI curve in the data sets of each group and the fundamental wave by the NCC algorithm, sequencing the waveform similarity from large to small, and in the data set Fⱼ of the KPI curve with the waveform similarity ranking as the top 95%, taking a minimum value of the waveform similarity as a grouping boundary line Bₖ of the group; and
Step J6: calculating a waveform similarity NCC_{Mi-Jk} between the data set Mᵢ of each segment of the KPI curve and the fundamental wave of each group by the NCC algorithm, judging whether the data set of each segment of the KPI curve belongs to the group by taking the grouping boundary line of each group as a reference, sequencing a data set of one segment of the KPI curve belonging to a plurality of groups at the same time according to a classification score Q, and grouping the data set Mᵢ of the KPI curve into a group with a minimum classification score Q to obtain grouping information of the data set of each segment of the KPI curve, wherein Q=((1−NCC_{Mi-J k})/(1−Bₖ))².

Preferably, the Step 9 is replaced by: replacing the numerical value of the similarity greater than the inflection point in the similarity matrix by 1, and replacing the numerical value of the similarity less than the inflection point by 0; and marking adjacent clusters with the similarity of 1 in the updated similarity matrix as the same similar group, and counting the number of clusters in each similar group.

Preferably, the monitoring indicators comprise physical parameters acquired by sensors on a generator and a monitored object with a material supply relationship, an electric energy transfer relationship, a thermal energy transfer relationship, a mechanical energy transfer relationship, a magnetic field transfer relationship, an energy conversion relationship or a signal control relationship with the generator.

Preferably, the physical parameters comprise a rotation speed, a real-time power generation capacity, a voltage and an excitation current of the generator, a vibration signal and a displacement signal of a generator shell, temperatures of a connection terminal of each electric transmission and transformation line electrically connected with a generator output cable and a crank, and a temperature and a humidity in an electric cabinet.

In the present invention, the monitoring indicators are physical parameters acquired by sensors on monitored objects with a material supply relationship, an electric energy transfer relationship, a thermal energy transfer relationship, a mechanical energy transfer relationship, a magnetic field transfer relationship, an energy conversion relationship or a signal control relationship in a same system.

The same system refers to a material production process, an energy production process or a control system consisting of the monitored objects above. Advantageously, because the monitored objects have direct or indirect material supply relationship, electric energy transfer relationship, thermal energy transfer relationship, mechanical energy transfer relationship, magnetic field transfer relationship, energy conversion relationship or signal control relationship in the same system, the physical parameters collected by the sensors on the monitored objects have mutual causal influence, which shows that the waveband chain of the KPI curve generated by different physical parameters due to the same inducement have similar characteristics. In order to discover such waveband chain, it is necessary to make the sliding window with appropriate width slide along the KPI curve, a unit segment of the KPI curve is intercepted from the window, and several wavebands of equal length are extracted from the unit segment of the KPI curve. Based on a similarity between the characteristic fundamental wave and the waveband, a label of each waveband in the unit segment of the KPI curve is marked, so that the unit segment of the KPI curve becomes a waveband chain with a label sequencing characteristic, so that every time the window slides on the KPI curve, one waveband chain is obtained, all waveband chains are of the same length, classification labels of the wavebands are different in sequencing, and after all waveband chains obtained by the sliding window are arranged according to a time dimension based on different sequencing characteristics of the waveband chains, a causal relationship of waveband chains with different characteristics in the time dimension may be obtained based on a sequence mining algorithm SPADE, expert evaluation and knowledge map fusion, which is conductive to supplementing a knowledge system of an expert for fault verification in the system and discovering a correlation of monitoring indicators failed to be discovered before, so that a new early warning control relationship and a regulation threshold may be established based on a correlation between newly discovered monitoring indicators in operation, thus improving system stability of each monitored object in the same system.

The significance of the method for processing data of the KPI curve above is that the unit segment of the KPI curve intercepted by the window from many KPI curves generated by monitoring has appropriate time sequence data length, and covers a length of most waveband chains, which is conductive to overall characteristic recognition of the waveband chain and sequence relationship mining from a plurality of waveband chains sequenced by time, thus reducing a calculation amount and improving the accuracy of causal relationship mining.

A second object of the present invention is to provide a KPI curve data processing method for marking characteristics of a waveband of a KPI curve, comprising the following steps of:
Step 1: establishing a waveform according to a relationship between historical data and time of monitoring indicators in a same system is filtered and forms a KPI curve of at least one monitoring indicator, wherein each monitoring indicator is one attribute of a data point of the KPI curve, and the same system refers to a material production process, an energy production process or a control system consisting of monitored objects with direct or indirect material supply relationship, electric energy transfer relationship, thermal energy transfer relationship, mechanical energy transfer relationship, magnetic field transfer relationship, energy conversion relationship or signal control relationship; and the monitoring indicators are physical parameters acquired by sensors on the monitored objects;
Step 2: segmenting the KPI curve into several wavebands with a time sequence width of 1 s, clustering the wavebands to form a plurality of clusters according to a non-time dimension of the wavebands, and extracting a fundamental wave of each cluster;
after the Step 10, further comprises the following steps of: Step 11: segmenting each KPI curve processed in the Step 1 into several window segments of the KPI curve with a time sequence width being a total time interval according to a preset sliding window first, and segmenting the window segment of the KPI curve into a data set M′ᵢ of an i segment of the KPI curve with a time sequence width of 1 s according to the segmenting method in the Step 2, wherein each segment is one waveband; and
comparing a similarity between each fundamental wave obtained in the Step 2 and each waveband in each window of each KPI curve one by one, sequencing the waveband according to the similarity from large to small, discovering a grouping boundary line according to the sequence, grouping the wavebands to form a label chain composed of fundamental wave labels, and obtaining mode waveforms of different KPI curves, which are called a KPI curve code pattern rearrangement table; and
Step 12: putting different KPI curve code pattern rearrangement tables into one dimension by time dimension unification to obtain a KPI curve code pattern rearrangement association table.

Advantageously, Label information obtained after processing in Step 12 contains a waveband label, which is a fundamental wave type and time arrangement information of a fundamental wave label. The total time interval is set as the width of the sliding window, the window is used for segmenting the KPI curve into several segments, and the time width of each segment covers the similar group with the maximum time length obtained in the Step 9. By scanning the KPI curve through the sliding window, consecutively appearing clusters can be quickly segmented into one window, and then can be quickly clustered into a same waveform category, so that a calculation amount is reduced, and the wavebands of the KPI curve can be integrally classified by the characteristics of the label chain, and reducing the possibility of knowledge omission.

Preferably, the steps after segmenting the window segment of the KPI curve into the wavebands in the Step 11 comprise: calculating the similarity between each fundamental wave obtained in the Step 2 and each waveband in each window of each KPI curve by the NCC algorithm one by one to obtain NCCM′_{i-Jk}, sequencing the similarity from large to small, in the waveband with the waveform similarity ranking as the top 95%, taking a minimum value of the waveform similarity as a grouping boundary line B′ₖ of the group, taking the grouping boundary line of each group as a reference, judging whether a data set M′ᵢ of each segment of the KPI curve belongs to the group, sequencing a data set M′ᵢ of one segment of the KPI curve belonging to a plurality of groups at the same time according to a classification score Q′, and grouping the data set Mᵢ of the KPI curve into a group with a minimum classification score Q′ to form the label chain composed of the fundamental wave labels, and obtaining mode waveforms of different KPI curves, which are called the KPI curve code pattern rearrangement table, wherein Q′=((1−NCCM′_{i-Jk})/(1−B′ₖ))².

Further, between the Step J2 and the Step 1, the method further comprises the following steps of:

In Z01, a spectrum intensity map of the KPI curve is extracted by Fourier transform.

In Z02, a highest point of a vibration amplitude is extracted to calculate a corresponding period, which is a to-be-detected period.

In Z03, a hypothetical period is set, which is an expected period, when a length of the to-be-detected period is within a range of 95% to 105% of the expected period, relevant intensity detection is carried out on the to-be-detected period, and when a spectrum intensity is sufficient, the to-be-detected period is regarded as a period meeting requirements, the filtered KPI curve is labeled according to a periodic difference of the KPI curve, which is called a KPI curve period label.

Further, between the Step J2 and the Step Z03, the method further comprises the following steps of:
Z04: calculating a pairwise similarity of each KPI curve by the NCC algorithm, expanding the similarity to form a diagonal similarity matrix, and filling the similarity into the similarity matrix, wherein sequence numbers of rows and columns in the matrix are serial numbers of the KPI curves, and a number of rows and a number of columns in the similarity matrix are numbers of the KPI curves; and
Z05: marking the cluster categories with different KPI curve labels by the spectral clustering algorithm according to the similarity matrix above, which are called KPI curve business labels.

A third object of the present invention is to provide a KPI curve data processing method for marking characteristics of a waveband of a log KPI curve, and the log KPI curve is generated by the following steps of:
Step F1: setting a training sentence set composed of training sentences, obtaining, by industrial control devices in a same industrial control system, fault logs based on the monitoring indicators, respectively constituting linguistic data in the fault logs and each training sentence into a sentence pair to be processed, calculating a similarity, and deleting linguistic data with a similarity lower than a first threshold;
Step F2: carrying out word segmentation on the remaining linguistic data in the Step F1, generating a segmented word queue composed of a plurality of characteristic words, and carrying out part-of-speech tagging on the plurality of characteristic words to obtain a part-of-speech queue of the linguistic data;
Step F3: when the part-of-speech queue contains a plurality of special characteristic words corresponding to special parts of speech, obtaining a boundary and a category of a named entity from the plurality of special characteristic words by a named entity recognition model, and updating the parts of speech of the special characteristic words in the part-of-speech queue into the boundary and the category of the named entity to obtain an updated part-of-speech queue, wherein the special parts of speech comprise numerals and temporal words;
Step F4: classifying the remaining linguistic data according to the tagging of the remaining linguistic data in the Step F3, counting a frequency of occurrence of each part-of-speech queue, sequencing the part-of-speech queue in a descending order, selecting a part-of-speech queue with a sequence greater than a second threshold, counting frequencies of occurrence of verbs and nouns in each part-of-speech queue, sequencing the part-of-speech queue in a descending order, sequentially selecting top two part-of-speech queue sets from the above two sequences according to a sequencing threshold, and extracting linguistic data corresponding to an intersection of the two part-of-speech queue sets to establish a true training set;
Step F5: selecting a segmented word queue with a part-of-speech tag combination of [n,v,n] from the linguistic data of the true training set, wherein n represents a part-of-speech of noun and v represents a part-of-speech of verb, and extracting first and second segmented words with a part-of-speech of noun or proper noun from the segmented word queue as a first event and a second event respectively to form an event tuple;
Step F6: based on an existing fault event relation table, discovering an event association rule of the event tuple by a Snowball algorithm, and discovering an associated event group in the event tuple according to the event association rule, which refers to generating a log key event relation table;
Step F7: repeating the Step F6 based on the log key event relation table until convergence; and
Step F8: taking each event relationship generated in the Step F7 as a log key event label to mark the fault logs, taking a frequency of occurrence of each log key event label per minute as a monitoring indicator to establish each log KPI curve, and smoothing each log KPI curve by a Gaussian kernel;
In the KPI curve data processing method used for marking characteristics of a waveband of a log KPI curve, the KPI curves in the Step 1 to the Step 12 are replaced by the log KPI curves;
the Step 1 to the Step 3 are replaced by:
Step G1: merging a data point set of each minute in all log KPI curves, then segmenting the merged product into several wavebands with a time width of s minutes, clustering the wavebands to form a plurality of clusters according to a non-time dimension of the wavebands, extracting a fundamental wave of each cluster, comparing a similarity between data of each waveband and the fundamental wave of each cluster, discovering a grouping boundary line of each cluster, and grouping the data of each waveband of each cluster; and
Step G2: extracting a time stamp of a data set of each segment of the log KPI curve classified into different groups to obtain a time stamp list of each group;
the Step 11 is replaced by: segmenting each log KPI curve into several window segments of the log KPI curve with a time sequence width being a total time interval according to the sliding window obtained in the Step 10 first, and segmenting the window segment of the log KPI curve into a data set M′ᵢ of an i segment of the log KPI curve with a time sequence width of 1 minute according to the segmenting method in the Step G1, wherein each segment is one waveband; and
comparing a similarity between each fundamental wave obtained in the Step G1 and each waveband in each window of each log KPI curve one by one, sequencing the waveband according to the similarity from large to small, discovering a grouping boundary line according to the sequence, grouping the wavebands to form a label chain composed of fundamental wave labels, and obtaining mode waveforms of different KPI curves, which are called a KPI curve code pattern rearrangement table.

Further, in the Step F1, the calculating the similarity comprises the following steps of: respectively carrying out word segmentation on sentences in the sentence pair based on a pre-established corpus, wherein the pre-established corpus comprises an industry corpus and a general corpus;
converting each characteristic word of the sentence subjected to word segmentation into a word vector, respectively calculating a similarity of each sentence pair by a cosine similarity, and deleting the linguistic data when the similarity is lower than the first threshold.

Further, the steps after segmenting the window segment of the KPI curve into the wavebands in the Step 11 comprise: calculating the similarity between each fundamental wave obtained in the Step G1 and each waveband in each window of each KPI curve by the NCC algorithm one by one to obtain NCCM′_{i-Jk}, sequencing the similarity from large to small, in the waveband with the waveform similarity ranking as the top 95%, taking a minimum value of the waveform similarity as a grouping boundary line B′k of the group, taking the grouping boundary line of each group as a reference, judging whether a data set M′i of each segment of the KPI curve belongs to the group, sequencing a data set M′i of one segment of the KPI curve belonging to a plurality of groups at the same time according to a classification score Q′, and grouping the data set Mᵢ of the KPI curve into a group with a minimum classification score Q′ to form the label chain composed of the fundamental wave labels, and obtaining mode waveforms of different KPI curves, which are called the KPI curve code pattern rearrangement table, wherein Q′=((1−NCCM′_{i-Jk})/(1−B′ₖ))².

Further, after the Step F8, the method further comprises the following steps of:
Z01: extracting a spectrum intensity map of the log KPI curve by Fourier transform;
Z02: extracting a highest point of a vibration amplitude to calculate a corresponding period, which is a to-be-detected period; and
Z03: setting a hypothetical period, which is an expected period, when a length of the to-be-detected period is within a range of 95% to 105% of the expected period, carrying out relevant intensity detection on the to-be-detected period, when a spectrum intensity is sufficient, regarding the to-be-detected period as a period meeting requirements, and labeling a filtered log KPI curve according to a periodic difference of the log KPI curve, which is called a log KPI curve period label.

Further, after the Step Z03, the method further comprises the following steps of:
Z04: calculating a pairwise similarity of each log KPI curve by the NCC algorithm, expanding the similarity to form a diagonal similarity matrix, and filling the similarity into the similarity matrix, wherein sequence numbers of rows and columns in the matrix are serial numbers of the log KPI curves, and a number of rows and a number of columns in the similarity matrix are numbers of the log KPI curves; and
Z05: marking the cluster categories with different log KPI curve labels by the spectral clustering algorithm according to the similarity matrix above, which are called KPI curve business labels.

Preferably, in order to realize the KPI curve data processing method provided in the third object, the following improvements are made to realize keyword extraction based on a log, the Step F7 to the Step F8 are replaced by:
Step f7: then processing the part-of-speech queue obtained in the Step F3 according to the Step F5 to obtain the true event tuple, and repeating the Step F6 to obtain the log key event relation table of the true event tuple until convergence of the Step F6;
Step f8: taking each event in the log key event relation table as a keyword, counting a frequency cᵢ of each keyword, wherein i represents a sequence number of the keyword, combining In(cᵢ) corresponding to all keywords into a set, and when the In(cᵢ) is lower than a 3-sigma lower limit of the set, deleting corresponding keywords, and taking reserved keywords as the keywords;
Step f9: taking a frequency of occurrence of each keyword per minute as a monitoring indicator to establish a KPI curve of each keyword;
Step f10: calculating a pairwise similarity of the KPI curve of each keyword by the NCC algorithm, expanding the similarity to form a diagonal similarity matrix, and filling the similarity into the similarity matrix, wherein sequence numbers of rows and columns in the matrix are serial numbers of the KPI curves of the keywords, a number of rows and a number of columns in the similarity matrix are numbers of the KPI curves of the keywords, and a numerical value in the similarity matrix is the similarity between the KPI curve of each keyword;
Step f11: outputting different cluster categories according to the similarity matrix above by a spectral clustering algorithm, and marking the different cluster categories with different log key event labels; and
Step f12: merging and counting frequencies of occurrence of the same type of log key event labels in the same time period to obtain a log histogram of each log key event label, and smoothing the log histogram by the Gaussian kernel to obtain each log KPI curve.

Preferably, in the Step F1, the calculating the similarity comprises the following steps of: respectively carrying out word segmentation on sentences in the sentence pair based on a pre-established corpus, wherein the pre-established corpus comprises an industry corpus and a general corpus; and
converting each characteristic word of the sentence subjected to word segmentation into a word vector, respectively calculating a similarity of each sentence pair by a cosine similarity, and deleting the linguistic data when the similarity is lower than the first threshold.

Preferably, between the Steps f9 and f10, the method further comprises the following step of: smoothing the KPI curve of each keyword by the Gaussian kernel.

Advantageously, a same industrial control system consists of industrial control devices with direct or indirect material supply relationship, electric energy transfer relationship, thermal energy transfer relationship, mechanical energy transfer relationship, magnetic field transfer relationship, energy conversion relationship or signal control relationship, the industrial control devices in the same industrial control system obtain fault logs based on the monitoring indicators, and because the monitoring indicators are correlated, the fault logs are also correlated: Step F1 a sentence with grammatical and semantic structures used for reference, behavior record and state description is selected from the fault logs, such as: [what is an object], [the object completes a certain task], [in a certain state] and [how much is a certain item], and these sentences have less ambiguity in description structure, which is conducive to removing an error log from the fault logs and keeping an industrial record log; Step F3 parts of speech of numerical values and time are the same before processing, inaccurate recognition is easy to occur during classification, and with the help of named entity recognition, accurate parts of speech may be simply and clearly marked; and Steps F4˜F6 events with correlation in the remaining linguistic data are selected according to an event relationship from complex keywords, and keywords are discovered from the events to obtain a natural law in the monitoring indicators (fault logs), thus excluding a large number of interference words. Text logs related numerical value limited events generated by the monitoring indicators in the industrial control system are processed based on the above steps, an event relationship is established from the logs, highly related event relationships are merged into the same group, high-frequency keywords are extracted, and the obtained keywords may be used for generating the log KPI curve periodically related to the KPI curve of the monitored indicator.

Advantageously, each record about the monitoring indicator in the log may have some text differences, direct clustering requires a lot of manual labeling and screening works, but frequencies of texts generated by monitoring indicators with strong correlation are similar, and after setting Steps f9˜f12, in this method, the keywords are clustered and merged based on a similarity of generated frequencies, and the same type of keywords share a label, so that a mapping relationship is generated between the label and the keywords, and the analysis on the KPI curve of the label can map a state of corresponding keywords, which facilitates analyzing a distribution law of various important keywords in the KPI curve.

Further, after the Step f12, the method further comprises the following steps of:
Z01: extracting a spectrum intensity map of the KPI curve or the log KPI curve by Fourier transform;
Z02: extracting a highest point of a vibration amplitude to calculate a corresponding period, which is a to-be-detected period; and
Z03: setting a hypothetical period, which is an expected period, when a length of the to-be-detected period is within a range of 95% to 105% of the expected period, carrying out relevant intensity detection on the to-be-detected period, when a spectrum intensity is sufficient, regarding the to-be-detected period as a period meeting requirements, and labeling a filtered KPI curve or log KPI curve according to a periodic difference of the KPI curve or the log KPI curve, which is called a KPI curve or log KPI curve period label.

Periodic detection is to mark a waveform with periodic and aperiodic signs, wherein the periodic sign represents the existence of a periodic and repeated event, and such type of information often refers to business information, such as state detection and rotating members in business knowledge; and in contrast, the aperiodic sign means event business. The signs are both business labels used in other steps and have nothing to do with other operations; and a similarity of periodic KPIs may be due to a similar relationship formed for various reasons, without business connection, while aperiodic KPIs are more likely to have a direct and indirect relationship.

Further, after the Step Z03, the method further comprises the following steps of:
Z04: calculating a pairwise similarity of each KPI curve or each log KPI curve by the NCC algorithm, expanding the similarity to form a diagonal similarity matrix, and filling the similarity into the similarity matrix, wherein sequence numbers of rows and columns in the matrix are serial numbers of the KPI curves or the log KPI curves, and a number of rows and a number of columns in the similarity matrix are numbers of the KPI curves or the log KPI curves; and
Z05: marking the cluster categories with different KPI curve labels or log KPI curve labels by the spectral clustering algorithm according to the similarity matrix above, which are called KPI curve business labels.

Further, in order to realize the two KPI curve data processing methods provided in the third object, the Step F6 comprises:
Step C1: matching a queue containing an event in the fault event relation table in the event tuple by the existing fault event relation table, and generating a template, wherein a format of the template is in a quintuple form, which respectively comprises <left>, a type of an event 1, <middle>, a type of an event 2 and <right>; len is an arbitrary set length, <left> is a vector representation of len words on the left of the event 1, <middle> is a vector representation of words between the event 1 and the event 2, and <right> is a vector representation of len words on the right of the event;
Step C2: clustering the generated templates, clustering templates with similarities greater than a third threshold into one class, generating a new template by an average method, and adding the template into a rule base for storing the templates, wherein, according to the Step C2, the format of the template is recorded as P=(\vec{L}, E₁, \vec{M}, E₂, \vec{R}) E₁ and E₂ respectively represent the type of the event 1 and the type of the event 2 of the template P, \vec{L} represents a vector representation length of three words on the left of E₁, \vec{M} represents a vector representation of words between E₁ and E₂, and \vec{R} represents a vector representation of a length of three words on the right of E₂, and according to the calculation of a similarity between the templates, a template 1: P₁=(\vec{L}₁, E₁, \vec{M}₁, E₂, \vec{R}₁) and a template 2: P₂=(\vec{L}₂, E₁′, \vec{M}₂, E₂′, \vec{R}₂) are obtained, when the condition that E₁=E′₁&&E₂=E′₂ is met, which means that the condition that a type E₁ of an event 1 of the template P₁ is the same as a type of an event 1 of the template P₂ and a type E₂ of an event 2 of the template P₁ is the same as a type E′₂ of an event 2 of the template P₂ is met, a similarity between the template P₁ and the template P₂ is calculated by μ₁\vec{L₁}\vec{L₂}+μ₂\vec{M₁}\vec{M₂}+μ₃\vec{R₁}\vec{R₂}, wherein μ₁, μ₂ and μ₃ are weights, and because \vec{M₁}\vec{M₂} has a great influence on a calculation result of the similarity between the templates, μ₂>μ₁>μ₃ is set; and when the condition E₁=E′₁&&E₂=E′₂ is not met, the similarity between the template P₁ and the template P₂ is recorded as 0;
Step C3: calculating a similarity between a template of the event tuple obtained in the Step C1 and a template in the rule base one by one, discarding a template with a similarity less than the third threshold, and adding an event in a template with a similarity greater than the third threshold into the log key event relation table to replace the fault event relation table; and
Step C4: repeating the Steps C1 to C3 until no template needs to be discarded after processing in the Step C3, which means that no new event tuple or rule is capable of being discovered.

Advantageously, the label information obtained after processing the log KPI curve contains all information of all wavebands, comprising two representations of waveband and waveform, the waveband label is the fundamental wave type and the time arrangement information of the fundamental wave label, and the waveform label comprises the business label and the period label.

If different KPI curves use a same KPI curve business label, there may be a causal relationship, wherein the probability of aperiodic KPI curve is higher than that of the periodic KPI curve.

If different KPI curves have a same KPI curve segment code patter fundamental wave label in an adjacent time period, there may be a causal relationship, wherein the possibility of the KPI curve repeated for more times is higher.

Further, in order to realize the latter KPI curve data processing methods provided in the third object, the Step f7 is replaced by:
then processing the part-of-speech queue obtained in the Step F3 according to the Step F5 to obtain the true event tuple, repeating the Steps C1 to C3 to obtain the log key event relation table of the true event tuple until convergence of the Step C3, and discarding a template with a similarity less than a fourth threshold in the Step C3.

Further, in order to realize the two KPI curve data processing methods provided in the third object, the Step G1 comprises the following steps of:
Step H1: extracting a data point set of each minute in all log KPI curves into a same curve set L, and segmenting the curve set L into data sets Mᵢ of several segments of the log KPI curve with a time width of s, wherein i is a segment sequence number;
Step H2: calculating an Euclidean distance between data sets of various segments according to an attribute of the data set of each segment of the log KPI curve by a dbscan algorithm, and clustering a data set of an i segment of the log KPI curve to obtain k cluster categories and abnormal items, wherein each cluster is data sets of one group, and the data sets of each group contain the data set Fⱼ of the j segment of the log KPI curve; and
Step H3: calculating the arithmetic mean value ΣFⱼ/j of the data set of the j segment of the log KPI curve in the data sets of each group as the fundamental wave of the group;
Step H4: calculating a waveform similarity between a data set Fⱼ of each segment of the log KPI curve in the data sets of each group and the fundamental wave by the NCC algorithm, sequencing the waveform similarity from large to small, and in the data set Fⱼ of the log KPI curve with the waveform similarity ranking as the top 95%, taking a minimum value of the waveform similarity as a grouping boundary line Bₖ of the group; and
Step H5: calculating a waveform similarity NCC_{Mi-Jk} between the data set Mᵢ of each segment of the log KPI curve and the fundamental wave of each group by the NCC algorithm, judging whether the data set of each segment of the log KPI curve belongs to the group by taking the grouping boundary line of each group as a reference, sequencing a data set of one segment of the log KPI curve belonging to a plurality of groups at the same time according to a classification score Q, and grouping the data set Mᵢ of the log KPI curve into a group with a minimum classification score Q to obtain grouping information of the data set of each segment of the log KPI curve, wherein Q=((1−NCC_{Mi-Jk})/(1−Bₖ))².

Advantageously, according to an overall similarity of the KPI curves, the KPI curves are clustered and classified to form various clusters with similar waveforms.

Further, after all label chains are arranged according to the time dimension, a causal relationship between different label chains occurring at different time is discovered based on a sequence mining algorithm SPADE or GSP.

The present invention has the beneficial effects as follows.

1. The total time interval is set as the width of the sliding window, the window is used for segmenting the KPI curve into several segments, and the time width of each segment covers the similar group with the maximum time length obtained in the Step S12. By scanning the KPI curve through the sliding window, consecutively appearing clusters can be quickly segmented into one window, and then can be quickly clustered into a same waveform category, so that a calculation amount is reduced, and the wavebands of the KPI curve can be integrally classified, thus being conducive to quickly forming a waveband chain composed of different types of wavebands for the whole KPI curve in a single window. A waveband chain corresponding to each window has its own characteristics, thus facilitating clustering and classification on the basis of the waveband chains, and reducing the possibility of knowledge omission.

2. When the second object of the present invention is achieved, the label information obtained after processing contains all information of all wavebands, comprising two representations of waveband and waveform, the waveband label is the fundamental wave type and the time arrangement information of the fundamental wave label, and the waveform label comprises the business label and the period label.

If different KPI curves use a same KPI curve business label, there may be a causal relationship, wherein the probability of aperiodic KPI curve is higher than that of the periodic KPI curve.

If different KPI curves have a same KPI curve segment code patter fundamental wave label in an adjacent time period, there may be a causal relationship, wherein the possibility of the KPI curve repeated for more times is higher.

3. When the third object of the present invention is achieved, specific nouns in texts of the fault logs generated by the industrial control devices of the same industrial control system have mutual causal influence, which is manifested in that pairs of nouns appear synchronously due to the same inducement, similar noun queues may be classified into one category, which is the event relationship obtained in the Step F8, the log KPI curve may be obtained by counting the frequency obtained through the event relationship, and the log KPI curve is synchronized with the indicator KPI curve obtained by monitoring analog quantities of the physical parameters by the industrial control devices, so that the indicator KPI curve can be classified into the waveband chain with the label sequencing characteristic by segmentation and clustering. Therefore, the log KPI curve also has the same characteristics of the waveband chains, and the characteristics of the waveband chains of the indicator KPI curve generated by different physical parameters due to the same inducement are similar, so that the characteristics of the waveband chains of the log KPI curve generated by different event relationships due to the same inducement are also similar.

In order to discover such waveband chain, it is necessary to make the sliding window with appropriate width slide along the log KPI curve, a unit segment of the log KPI curve is intercepted from the window, and several wavebands of equal length are extracted from the unit segment of the log KPI curve. Based on a similarity between the characteristic fundamental wave and the waveband, a label of each waveband in the unit segment of the log KPI curve is marked, so that the unit segment of the log KPI curve becomes a waveband chain with a label sequencing characteristic, so that every time the window slides on the log KPI curve, one waveband chain is obtained, all waveband chains are of the same length, classification labels of the wavebands are different in sequencing, and after all waveband chains obtained by the sliding window are arranged according to a time dimension based on different sequencing characteristics of the waveband chains, a causal relationship of waveband chains with different characteristics in the time dimension may be obtained based on a sequence mining algorithm SPADE, expert evaluation and knowledge map fusion, which means to obtain a causal relationship between the event relationship and the event relationship, and is conductive to supplementing a knowledge system of an expert for fault verification in the system and discovering a correlation of monitoring indicators failed to be discovered before, so that a new early warning control relationship and a regulation threshold may be established based on a correlation between newly discovered monitoring indicators in operation, thus improving system stability of each monitored object in the same system.

The technical problem solved by the present invention is similar to that of the prior art CN110726898B, the step of obtaining a feature compression code by inputting a waveform to a self-coding network in CN110726898B is equivalent to the step of extracting the waveband chain based on the KPI curve or inducing the event tuple based on the fault logs. The step of inputting a compressed code into a classification model to obtain a type of a fault waveform is equivalent to the step of obtaining the causal relationship of waveband chains with different characteristics in the time dimension based on the sequence mining algorithm SPADE, the expert evaluation and the knowledge map fusion; or is equivalent to the step of inputting the event tuple into the existing fault event relation table (classification model) and classifying the event tuple into the associated event group based on Snowball.

The step of clustering and classifying the keyword KPI curve into the log KPI curve in the present invention is also equivalent to the step of obtaining a feature compression code by inputting a waveform to a self-coding network in CN110726898B.

### BRIEF DESCRIPTION OF THE DRAWINGS

FIG. 1 shows a KPI curve established from a monitoring indicator in the same system, wherein the standardization in FIG. 1 refers to scaling values of a certain column of numerical characteristics to a state in which a mean value is 0 and a variance is 1, and values on a vertical coordinate of the KPI curve are obtained by dividing a difference between a real-time value and a mean value by the variance;

FIG. 2 shows two KPI curves with high similarity obtained after comparison by an NCC algorithm;

FIG. 3 shows a label chain composed of formed fundamental wave labels;

FIG. 4 shows a log KPI curve generated from fault logs generated based on industrial control devices in the same industrial control system; and

FIG. 5 shows categories after log KPI curves are generated according to texts of fault logs and clustered.

### DETAILED DESCRIPTION OF SOME EMBODIMENTS

The technical solutions in the embodiments of the present invention will be clearly and completely described as follows in combination with the drawings in the examples of the present invention, but obviously, the described examples are only a part of the embodiments of the present invention, rather than all the embodiments. Based on the examples of the present invention, all other examples obtained by a person skilled in the art without creative efforts shall fall within the protection scope of the present invention.

In the following embodiments, a label chain and a waveband chain have the same meaning, and a unit segment of a KPI curve and a window segment of the KPI curve have the same meaning.

### Embodiment 1

A KPI curve data processing method used for setting a width of a sliding window for scanning a KPI curve comprises the following steps.

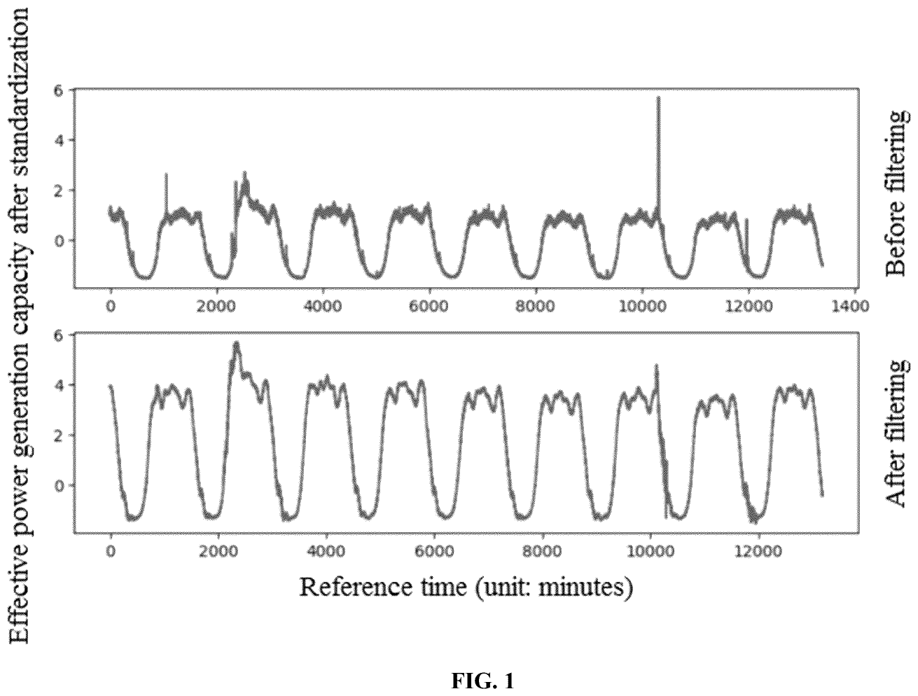

In Step S1, as shown in FIG. 1, a waveform is established according to a relationship between historical data and time of monitoring indicators in a same system to obtain a KPI curve of at least one monitoring indicator, wherein each monitoring indicator is one attribute of a data point of the KPI curve.

The above attributes are similar to values on a y axis/z axis in a three-dimensional coordinate system, coordinate values on each axis are in one dimension, and the x axis refers to time.

The monitoring indicators are physical parameters acquired by sensors on monitored objects with a material supply relationship, an electric energy transfer relationship, a thermal energy transfer relationship, a mechanical energy transfer relationship, a magnetic field transfer relationship, an energy conversion relationship or a signal control relationship in the same system.

The same system refers to a material production process, an energy production process or a control system consisting of the monitored objects above.

For example, the same system consists of a steam turbine, a generator, a cable, a transformer and an electrical cabinet in a power generation system, and monitoring indicators of the system comprise a rotation speed, a real-time power generation capacity, a voltage and an excitation current of the generator, a vibration signal and a displacement signal of a generator shell, temperatures of a connection terminal of each key electric transmission and transformation line electrically connected with a generator output cable and a crank, and a temperature and a humidity in an electric cabinet.

In Step S2, a stride sliding window is set, with a step length of s, wherein s=1 second, and the KPI curve is segmented into data sets Mᵢ of several segments of the KPI curve with a time width of s according to a window width, wherein i is a segment sequence number.

In Step S3, an Euclidean distance between data sets of various segments is calculated according to an attribute of the data set of each segment of the KPI curve by a dbscan algorithm, and a data set of an i segment of the KPI curve is clustered to obtain k cluster categories and abnormal items, wherein each cluster is data sets of one group, and the data sets of each group contain a data set Fⱼ of a j segment of the KPI curve.

In Step S4, an arithmetic mean value ΣFⱼ/j of the data set of the j segment of the KPI curve in the data sets of each group is calculated as the fundamental wave of the group.

In Step S5, a waveform similarity between a data set Fⱼ of each segment of the KPI curve in the data sets of each group and the fundamental wave is calculated by the NCC algorithm, the waveform similarity is sequenced from large to small, and in the data set Fⱼ of the KPI curve with the waveform similarity ranking as the top 95%, a minimum value of the waveform similarity is taken as a grouping boundary line Bₖ of the group.

In Step S6, a waveform similarity NCC_{Mi-Jk} between the data set Mᵢ of each segment of the KPI curve and the fundamental wave of each group is calculated by the NCC algorithm, whether the data set of each segment of the KPI curve belongs to the group is judged by taking the grouping boundary line of each group as a reference, a data set of one segment of the KPI curve belonging to a plurality of groups at the same time is sequenced according to a classification score Q, and the data set Mᵢ of the KPI curve is grouped into a group with a minimum classification score Q to obtain grouping information of the data set of each segment of the KPI curve, wherein Q=((1−NCC_{Mi-Jk})/(1−Bₖ))².

The larger the NCC_{Mi-Jk}, the smaller the Q, which indicates that the Mⁱ is more similar to a cluster category k. When the similarity NCC_{Mi-Jk} between the data set Mⁱ of the KPI curve and different cluster categories is the same, the smaller the Bₖ, the higher the similarity NCC_{M i-J k} between the cluster category Mⁱ and the cluster category k in waveform similarity sequencing of the cluster categories. The possibility of the data set Mᵢ of the KPI curve in candidate clusters may be calculated through this formula, thus calculating the most likely cluster category.

In Step S7, a time stamp of the data set of each segment of the KPI curve classified into different groups is extracted to obtain a time stamp list of each group.

In Step S8, shift subtraction is carried out on the time stamp list of each group, which refers to subtracting a starting time stamp of the next item from a starting time stamp of the current item in each time stamp list to obtain an event trigger interval list.

An event trigger interval is a time interval between data sets of two adjacent segments of the KPI curve in the data sets of each group.

In Step S9, event trigger intervals of each cluster are merged into a time interval KPI set, and a similarity between the time interval KPI sets of various clusters is calculated according to NCC. If the time interval KPI sets of different clusters are similar, the waveforms of the clusters are similar in a total time width.

In Step S10, the similarity between the time interval KPI sets of various clusters obtained in the Step S9 is expanded to form a similarity matrix. As shown in Table 1, a to d are sequence numbers of the clusters, a number of rows and a number of columns of the similarity matrix are numbers of the clusters, numerical values in the similarity matrix are the similarities between the time interval KPI sets of the clusters, and the similarity matrix is a diagonal matrix.

TABLE 1

| | a | b | c | d |
|---|---|---|---|---|
| a | 1 | 0.32 | 0.96 | 0.46 |
| b | 0.32 | 1 | 0.55 | 0.96 |
| c | 0.96 | 0.55 | 1 | 0.23 |
| d | 0.46 | 0.96 | 0.23 | 1 |

In Step S11, the similarity between the time interval KPI sets of various clusters is sequenced according to a numerical value, then the numerical value of the similarity is fit into a smooth line, and a boundary line of the similarity between the time interval KPI sets of various clusters is obtained according to an inflection point method.

In Step S12, the numerical value of the similarity greater than the inflection point in the similarity matrix is replaced by 1, and the numerical value of the similarity less than the inflection point is replaced by 0, as shown in Table 2.

TABLE 2

| | a | b | c | d |
|---|---|---|---|---|
| a | 1 | 0 | 1 | 0 |
| b | 0 | 1 | 0 | 1 |
| c | 1 | 0 | 1 | 0 |
| d | 0 | 1 | 0 | 1 |

In Step S13, adjacent clusters with the similarity of 1 in the similarity matrix obtained in the Step S12 are marked as a same similar group, and the number of clusters in each similar group is counted.

In Step S14, a total time interval of one group with a largest number of clusters in the similar group is calculated.

The total time interval is set as a width of a sliding window, the window is used for segmenting the KPI curve into several segments, and the time width of each segment covers the similar group with the maximum time length obtained in the Step S12. By scanning the KPI curve through the sliding window, consecutively appearing clusters can be quickly segmented into one window, and then can be quickly clustered into a same waveform category, so that a calculation amount is reduced, and the wavebands of the KPI curve can be integrally classified, thus reducing the probability of knowledge omission.

The above NCC (normalized cross correlation) algorithm is defined as:

$${N}_{h} = \frac{{\sum }_{t = 1}^{n - h} {x}_{t} * {y}_{t + h}}{\vert {\sum }_{t = 1}^{n - h} {x}_{t} \vert \vert {\sum }_{t = 1}^{n - h} {y}_{t + h} \vert}$$

wherein xₜ is a background waveform, yₜ₊ₕ is a template waveform, a value of the NCC is between −1 and 1, −1 represents that waveforms before and after transformation are opposite, 0 represents that the two waveforms are orthogonal, and 1 represents that the two waveforms are exactly the same. The NCC only describes a macroscopic similarity of the two waveforms, which has nothing to do with a waveform amplitude and energy attenuation.

### Embodiment 2

### Preprocessing of the KPI Curve

In Step A1, a waveform is established according to a relationship between historical data and time of various monitoring indicators in a power station system network. For example, a waveform is established according to a relationship between a power generation capacity and time of a certain generator, so as to obtain a waveform diagram of a KPI curve before filtering as shown in FIG. 1, and then a filtered KPI curve as shown in FIG. 1 is formed by filtering.

The filtering is used for removing monitoring indicators with numerical values ranking as the largest 5% and the smallest 5% of the monitoring indicators in the waveform diagram of the KPI curve, and the numerical values of the removed monitoring indicators are filled by interpolation.

### Embodiment 3

A KPI curve data processing method used for marking characteristics of a waveband of a KPI curve comprises the following steps.

The filtered KPI curve in Embodiment 2 is preprocessed according to the following steps.

In Step A2, classification and labeling are carried out according to the periodicity of the KPI curve.

1 The KPI curve of each monitoring indicator is periodically verified and checked, and the filtered KPI curve is labeled according to a periodic difference of the KPI curve, which is called a KPI curve period label.

The periodic verification and check comprise the following steps.

In Z01, a spectrum intensity map of the KPI curve is extracted by Fourier transform.

In Z02, a highest point of a vibration amplitude is extracted to calculate a corresponding period, which is a to-be-detected period.

In Z03, a hypothetical period is set, which is an expected period, when a length of the to-be-detected period is within a range of 95% to 105% of the expected period, relevant intensity detection is carried out on the to-be-detected period, and when a spectrum intensity is sufficient, the to-be-detected period is regarded as a period meeting requirements.

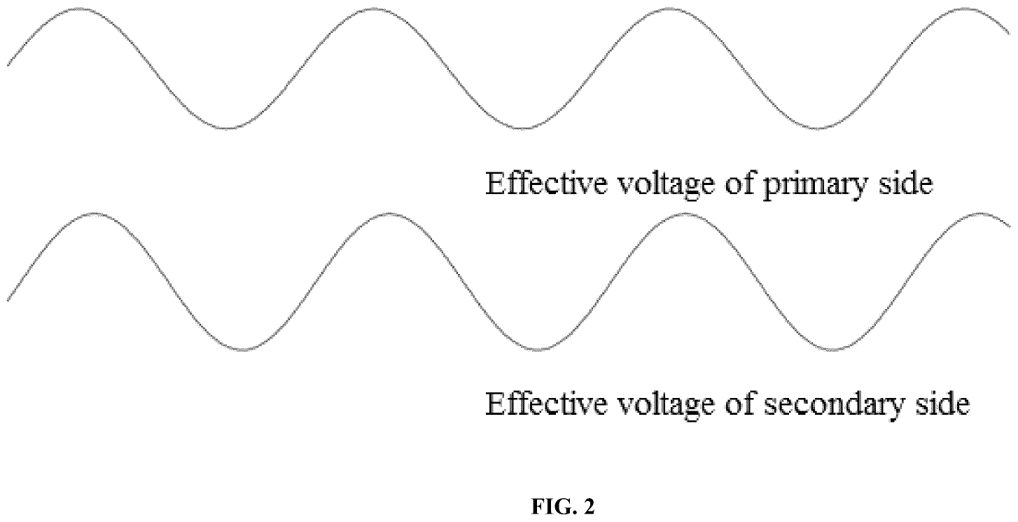

As shown in FIG. 2, according to the monitoring indicators, a voltage is periodically verified and checked, and filtered two voltage-time relationship curves are marked as an effective voltage of a primary side and an effective voltage of a secondary side.

In Step A3, classification and labeling are carried out according to the similarity of the KPI curve.

A pairwise similarity of each KPI curve is calculated by the NCC algorithm, the similarity is expanded to form a diagonal similarity matrix, and the similarity is filled into the similarity matrix, wherein sequence numbers of rows and columns in the matrix are serial numbers of the KPI curves, a number of rows and a number of columns in the similarity matrix are numbers of the KPI curves, and a numerical value in the similarity matrix is the similarity between each KPI curve.

Cluster categories are marked with different log KPI curve labels by a spectral clustering algorithm according to the similarity matrix above, which are called KPI curve business labels.

“Spectral clustering algorithm. Zhihu” introduces a classification method of spectral clustering.

In Step A4, the KPI curve is segmented into characteristic wavebands with different characteristics.

A set Lis initialized, Ln, a sliding window is set, with a width of m, and m represents a time sequence width. According to the method in Embodiment 1, m∈(12˜60) is solved, which meets the need of fault judgment. According to the Steps S2 to S4 in Embodiment 1, the KPI curve in the window is segmented into wavebands with a time sequence width of 1 s, and the wavebands are clustered and grouped to obtain a fundamental wave of each group.

A data point set of each time sequence in all KPI curves processed in the Step A3 is extracted into the same set L, and the set L is segmented into several segments according to a window width.

The data point set in each window is segmented into several small segments according to the time sequence width of 1 s, and each small segment is one data set Mᵢ of the KPI curve, wherein i is a segment sequence number.

An Euclidean distance between data sets of various segments is calculated according to an attribute of the data set of each segment of the KPI curve by a dbscan algorithm, and a data set of an i segment of the KPI curve is clustered to obtain k cluster categories and abnormal items, wherein each cluster is data sets of one group, which is marked as a different waveband, and the data sets of each group contain a data set Fⱼ of a j segment of the KPI curve.

An arithmetic mean value ΣFⱼ/j of the data set of the j segment of the KPI curve in the data sets of each group is calculated as the fundamental wave of the group, which is called a KPI curve segment code pattern fundamental wave.

In Step A5, the waveform of each KPI curve is marked according to the fundamental wave.

Each KPI curve processed in the Step A3 is segmented into a data set M′ᵢ of an i segment of the KPI curve with a time sequence width of 1 s according to the Step A4 first, wherein each segment is one waveband.

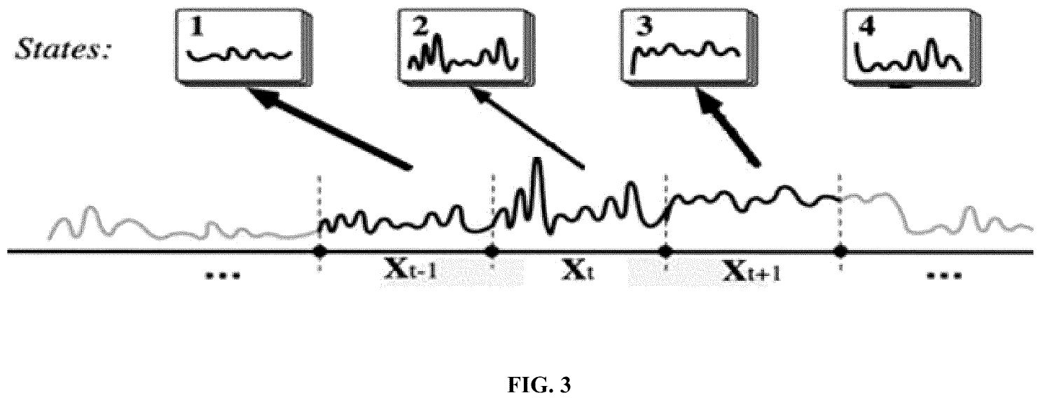

The similarity between each fundamental wave obtained in the Step A4 and each waveband in each window of each KPI curve is calculated by the NCC algorithm one by one to obtain NCCM′_{i-Jk}, the similarity is sequenced from large to small, in the waveband with the waveform similarity ranking as the top 95%, a minimum value of the waveform similarity is taken as a grouping boundary line B′ₖ of the group, the grouping boundary line of each group is taken as a reference, whether a data set M′ᵢ of each segment of the KPI curve belongs to the group is judged, a data set M′ᵢ of one segment of the KPI curve belonging to a plurality of groups at the same time is sequenced according to a classification score Q′, the data set Mᵢ of the KPI curve is grouped into a group with a minimum classification score Q′ to form a label chain composed of fundamental wave labels as shown in FIG. 3, time information is added into the fundamental wave labels of the KPI curve, and mode waveforms of different KPI curves are obtained, which are called a KPI curve code pattern rearrangement table, wherein Q′=((1−NCCM′_{i-Jk})/(1−B′ₖ))².

Label information obtained after processing by the Step A5 contains all information of all wavebands, comprising two representations of waveband and waveform, a waveband label is a fundamental wave type, and a waveform label comprises a business label and a period label.

Therefore, every time the window slides on the KPI curve, one waveband chain is obtained, all waveband chains are of the same length, and classification labels of the wavebands are different in sequencing. In the embodiment, curve characteristics of KPI curves of different monitoring indicators with correlation are converted into sequencing characteristics of a label chain, and due to the correlation, the KPI curves have different amplitudes but similar periods and similar fluctuating paces, which is label arrangement, so that a large number of correlated KPI curves may be unified into label chains with consistent standards.

In Step A6, different KPI curve code pattern rearrangement tables are put into one dimension by time dimension unification to obtain a KPI curve code pattern rearrangement association table.

If different KPI curves use a same KPI curve business label, there may be a causal relationship, wherein the probability of aperiodic KPI curve is higher than that of the periodic KPI curve.

If different KPI curves have a same KPI curve segment code patter fundamental wave label in an adjacent time period, there may be a causal relationship, wherein the possibility of the KPI curve repeated for more times is higher.

After all label chains are arranged according to the time dimension, a causal relationship between different label chains occurring at different time may be discovered based on a sequence mining algorithm SPADE or GSP. If two events always occur in a pair, the two events are considered to be correlated, and if one event always occurs before the other event, the two events are considered to have a causal relationship, wherein the former is cause and the latter is effect, which is conductive to supplementing an expert's knowledge system for fault identification in the system, and discovering the correlation of the monitoring indicators not discovered before, so that new early warning control relationship and regulation threshold may be established based on the correlation between newly discovered monitoring indicators in operation, thus improving system stability of each monitored object in the same system.

### Embodiment 4

A KPI generation method based on log keyword clustering comprises the following steps.

In R1, fault logs obtained by industrial control devices in a same industrial control system network of a power station based on monitoring indicators are collected, an event tuple is established according to the fault logs, and the fault logs are processed by a snowball algorithm to establish an event relationship.

A method for establishing the event tuple comprises the following steps.

In F1, a training sentence set composed of training sentences is set, linguistic data are extracted from the fault logs to constitute a sentence pair to be processed with each training sentence respectively, and work segmentation is carried out on sentences in a sentence pair respectively based on a pre-built corpus, wherein the pre-built corpus comprises an industry corpus and a general corpus.

In F2, each characteristic word of the sentence subjected to word segmentation is converted into a word vector, a similarity of each sentence pair is respectively calculated by a cosine similarity, and the linguistic data are deleted when the similarity is lower than a threshold, for example, the threshold is set to be 0.9.

The Steps F1 and F2 are used for selecting a sentence with grammatical and semantic structures used for reference, behavior record and state description from the fault logs, according to general grammars of the fault logs in the industrial control system, such as: [what is an object], [the object completes a certain task], [in a certain state] and [how much is a certain item], these sentences have less ambiguity in description structure, which is conducive to removing an error log from the fault logs and keeping an industrial record log.

The word segmentation is carried out on the linguistic data by using a jieba.cut function during word segmentation, and the cut function is defined as follows:
def cut (sentence, cut_all=False, HMM=True)
wherein, sentence is a sentence sample to be subjected to word segmentation; cut_all is a mode of word segmentation, jieba word segmentation has two modes: a full mode and an accurate mode, which are selected by true and false respectively, and a default mode is false, that is, the accurate mode; and HMM is a hidden Markov chain, which is used in a theoretical model of word segmentation and turned on by default.

In F3, word segmentation is carried out on the remaining linguistic data in the Step F2, a segmented word queue composed of a plurality of characteristic words is generated, and part-of-speech tagging is carried out on the plurality of characteristic words to obtain a part-of-speech queue of the linguistic data.

During part-of-speech tagging, input words are returned to a category code by using a jieba.posseg.cut function. Qingyue Yang recorded use steps of the jieba.posseg.cut function and a part-of-speech classification table in “a part-of-speech table of jieba word segmentation”.

In F4, when the part-of-speech queue contains a plurality of special characteristic words corresponding to special parts of speech, obtaining a boundary and a category of a named entity from the plurality of special characteristic words by a named entity recognition model, and updating the parts of speech of the special characteristic words in the part-of-speech queue into the boundary and the category of the named entity to obtain a part-of-speech queue.

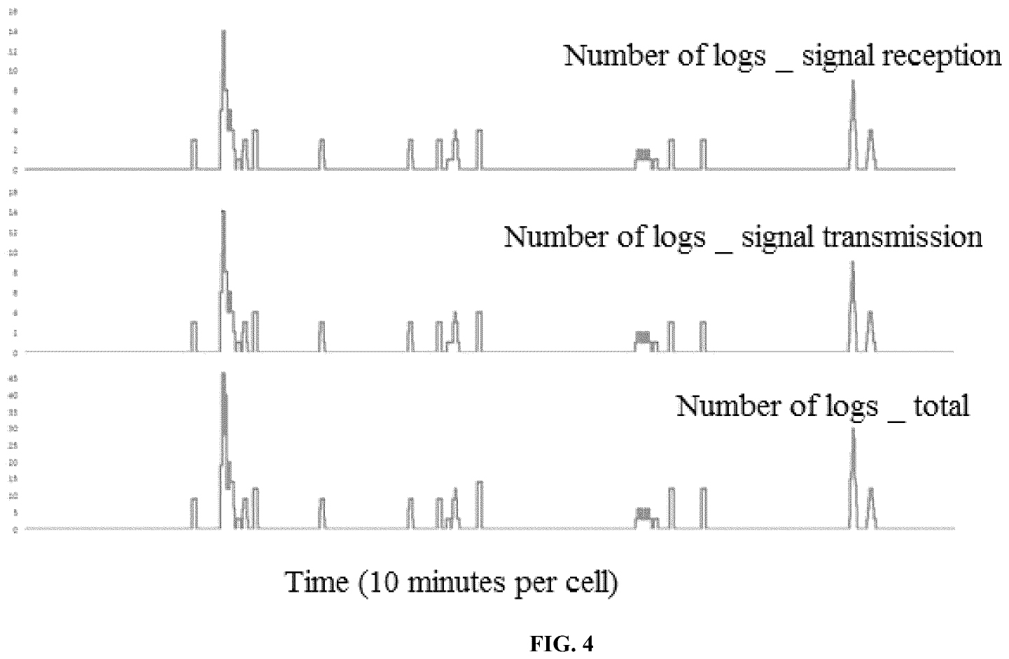

The special parts of speech comprise: numerals and time words. In an application scenario of the embodiment, only numerical values and time are prone to inaccurate recognition by part-of-speech classification. For example, the linguistic data “16:10:23 (I set) signal appearance and pulse allowance” in FIG. 4 is subjected to word segmentation to obtain a part-of-speech queue “{16: m,:: x, 10: m,:: x,23: m, (: x, I set: n,): x,signal: n, appearance: v,pulse: n,allowance: v}”, wherein: m, represents a numeral, :x, represents a character string,: n, represents a noun, and :v, represents a verb. The linguistic data “16:17:00 (I set) signal appearance and reception by another channel” is processed by the Step F4 to obtain a part-of-speech queue “{16:17:00: t, (: x, I set: n,): x,signal: n, appearance: v,another channel: n,reception: v}”, and this step avoids tagging parts of speech of time words that are difficult to be recognized as numerals, so that a queue containing the time words and a queue containing the numerals can be distinguished by the part-of-speech queue.

A named entity recognition model may recognize a named referent from the linguistic data to be processed. In a narrow sense, four kinds of named entities: personal names, place names, organization names and proper nouns are recognized. There are usually two parts: (1) entity boundary recognition; and (2) entity category (personal names, place names, organization names or others) determination. There are many methods for named entity recognition, such as a rule-based method, a characteristic template-based method and a neural network-based method, and the named entity recognition model may be established based on the above methods.

For example, the named entity recognition model (CRF) carries out entity tagging on the sentence “I came to Taojia Village”, and a result after correct tagging is: I/O come/O to/O Tao/B jia/M village/E (wherein O represents that a current word is not a geographical named entity, and B, M and E represent that current words are a head part, an inner part and a tail part of the geographical named entity respectively). When a linear chain CRF is used to solve the problem, (O, O, O, B, M, E) is a tagging sequence, and (O, O, O, B, M, E) is also a tagging choice.

In F5, the remaining linguistic data are classified according to the tagging of the remaining linguistic data in the Step F4, a frequency of occurrence of each part-of-speech queue is counted, and frequencies of occurrence of verbs and nouns in each part-of-speech queue are counted.

In F6, each part-of-speech queue is sequenced in a descending order according to the frequencies of occurrence of verbs and nouns respectively, top two part-of-speech queue sets are sequentially selected from the above two sequences according to a sequencing threshold, and linguistic data corresponding to an intersection of the two part-of-speech queue sets are extracted to establish a true training set.

In F7, a segmented word queue with a part-of-speech tag combination of [n,v,n] is selected from the linguistic data of the true training set, and first and second segmented words with a part-of-speech of noun or proper noun are extracted from the segmented word queue as a first event and a second event respectively to form an event tuple.

In F8, an event association rule of the event tuple is discovered by a Snowball algorithm, and an associated event group in the event tuple is discovered according to the event association rule.

In Step C1, a queue containing an event in the fault event relation table in the event tuple is matched by the existing fault event relation table, and a template is generated, wherein a format of the template is in a quintuple form, which respectively comprises <left>, a type of an event 1, <middle>, a type of an event 2 and <right>; len is an arbitrary set length, <left> is a vector representation of len words on the left of the event 1, <middle> is a vector representation of words between the event 1 and the event 2, and <right> is a vector representation of len words on the right of the event.

In Step C2, the generated templates are clustered, templates with similarities greater than a threshold of 0.7 are clustered into one class, a new template is generated by an average method, and the template is added into a rule base for storing the templates, wherein, according to the Step C2, the format of the template is recorded as P=(\vec{L}, E₁, \vec{M}, E₂, \vec{R}), E₁ and E₂ respectively represent the type of the event 1 and the type of the event 2 of the template P, \vec{L} represents a vector representation of a length of three words on the left of E1, represents a vector representation of words between E₁ and E₂, and \vec{R} represents a vector representation of a length of three words on the right of E₂, and according to the calculation of a similarity between the templates, a template 1: P₁=(\vec{L}₁, E₁, \vec{M}₁, E₂, \vec{R}₁) and a template 2: P₂=(\vec{L}₂, E₁′, \vec{M}₂, E₂′, \vec{R}₂) are obtained, when the condition that E₁=E′₁&&E₂=E′₂ is met, which means that the condition that a type E₁ of an event 1 of the template P₁ is the same as a type E′₁ of an event 1 of the template P₂ and a type E₂, of an event 2 of the template P₁ is the same as a type of an event 2 of the template P₂ is met, a similarity between the template P₁ and the template P₂ is calculated by μ₁\vec{L₁}\vec{L₂}+μ₂\vec{M₁}\vec{M₂}+μ₃\vec{R₁}\vec{R₂}, μ₁, μ₂ and μ₃ are weights, and because \vec{M₁}\vec{M₂} has a great influence on a calculation result of the similarity between the templates, μ₂>μ₁>μ₃ is set; and when the condition E₁=E′₁&E₂=E′₂ is not met, the similarity between the template P₁ and the template P₂ is recorded as 0.

The average method is to average the vectors of the templates in the same category to generate the new template, which may refer to “Snowball Algorithm for Relation Extraction-Programmer's Camp” reported in “https://www.pianshen.com/article/61161224295/”.

In Step C3, a similarity between a template of the event tuple obtained in the Step C1 and a template in the rule base is calculated one by one, a template with a similarity less than the threshold of 0.7 is discarded, and an event in a template with a similarity greater than the threshold of 0.7 is added into the log key event relation table to replace the fault event relation table.

In Step C4, the Steps C1 to C3 are repeated until no template needs to be discarded after processing in the Step C3.

In Step R2, each event relationship generated in the Step C4 is taken as a log key event label to mark the fault logs.

As shown in FIG. 4, a frequency of occurrence of each log key event label per minute is taken as a monitoring indicator to establish each log KPI curve, and each log KPI curve is smoothed by a Gaussian kernel.

In Step R3, classification and labeling are carried out according to the periodicity of the log KPI curve.

The log KPI curve of each even relationship is periodically verified and checked, and the log KPI curve smoothed by the Gaussian kernel is labeled according to a periodic difference of the log KPI curve, which is called a log KPI curve period label.

In Step D1, the periodic verification and check comprise the following steps.

In Z01, a spectrum intensity map of the log KPI curve is extracted by Fourier transform.

In Z02, a highest point of a vibration amplitude is extracted to calculate a corresponding period, which is a to-be-detected period.

In Z03, a hypothetical period is set, which is an expected period, when a length of the to-be-detected period is within a range of 95% to 105% of the expected period, relevant intensity detection is carried out on the to-be-detected period, and when a spectrum intensity is sufficient, the to-be-detected period is regarded as a period meeting requirements.

In Step R4, classification and labeling are carried out according to the similarity of the log KPI curve.

In Z04, a pairwise similarity of each log KPI curve is calculated by the NCC algorithm, the similarity is expanded to form a diagonal similarity matrix, and the similarity is filled into the similarity matrix, wherein sequence numbers of rows and columns in the matrix are serial numbers of the log KPI curves, a number of rows and a number of columns in the similarity matrix are numbers of the log KPI curves, and a numerical value in the similarity matrix is the similarity between each log KPI curve.

In Z05: the cluster categories are marked with different log KPI curve labels by a spectral clustering algorithm according to the similarity matrix above to obtain a mapping relationship (business implicit relationship) of the log key event labels.

A classification method of spectral clustering is introduced in “https://zhuanlan.zhihu.com/p/29849122”.

In Step R5, the KPI curve obtained in the Step R4 is preprocessed according to the steps in Embodiment 4.

### Embodiment 5

A method for marking characteristics of a waveband based on the log KPI curve obtained in Embodiment 1 comprises the following steps.

In Step H1, a data point set of each minute in all log KPI curves is extracted into a same curve set L, and the curve set Lis segmented into data sets Mᵢ of several segments of the log KPI curve with a time width of s, wherein i is a segment sequence number.

In Step H2, an Euclidean distance between data sets of various segments is calculated according to an attribute of the data set of each segment of the log KPI curve by a dbscan algorithm, and a data set of an i segment of the log KPI curve is clustered to obtain k cluster categories and abnormal items, wherein each cluster is data sets of one group, and the data sets of each group contain the data set Fⱼ of the j segment of the log KPI curve.

In Step H3, the arithmetic mean value ΣFⱼ/j of the data set of the j segment of the log KPI curve in the data sets of each group is calculated as the fundamental wave of the group.

In Step H4, a waveform similarity between a data set Fⱼ of each segment of the log KPI curve in the data sets of each group and the fundamental wave is calculated by the NCC algorithm, the waveform similarity is sequenced from large to small, and in the data set Fⱼ of the log KPI curve with the waveform similarity ranking as the top 95%, a minimum value of the waveform similarity is taken as a grouping boundary line Bₖ of the group.

In Step H5, a waveform similarity NCC_{Mi-Jk} between the data set Mᵢ of each segment of the log KPI curve and the fundamental wave of each group is calculated by the NCC algorithm, whether the data set of each segment of the log KPI curve belongs to the group is judged by taking the grouping boundary line of each group as a reference, a data set of one segment of the log KPI curve belonging to a plurality of groups at the same time is sequenced according to a classification score Q, and the data set Mᵢ of the log KPI curve is grouped into a group with a minimum classification score Q to obtain grouping information of the data set of each segment of the log KPI curve, wherein Q=((1−NCC_{Mi-Jk})/(1−Bₖ))².

The larger the NCC_{Mi-Jk}, the smaller the Q, which indicates that the Mᵢ is more similar to a cluster category k. When the similarity NCC_{Mi-Jk} between the data set Mᵢ of the log KPI curve and different cluster categories is the same, the smaller the Bₖ, the higher the similarity NCC_{Mi-Jk} between the cluster category Mᵢ and the cluster category k in waveform similarity sequencing of the cluster categories. The possibility of the data set Mᵢ of the log KPI curve in candidate clusters may be calculated through this formula, thus calculating the most likely cluster category.

In Step G2, a time stamp of a data set of each segment of the log KPI curve classified into different groups is extracted to obtain a time stamp list of each group.

Subsequent steps are similar to those in Embodiment 1.

In Step S8, shift subtraction is carried out on the time stamp list of each group, which refers to subtracting a starting time stamp of the next item from a starting time stamp of the current item in each time stamp list to obtain an event trigger interval list.

An event trigger interval is a time interval between data sets of two adjacent segments of the log KPI curve in the data sets of each group.

In Step S9, event trigger intervals of each cluster are merged into a time interval KPI set, and a similarity between the time interval KPI sets of various clusters is calculated according to NCC. If the time interval KPI sets of different clusters are similar, the waveforms of the clusters are similar in a total time width.

In Step S10, the similarity between the time interval KPI sets of various clusters obtained in the Step S9 is expanded to form a similarity matrix. As shown in Table 3, a to d are sequence numbers of the clusters, a number of rows and a number of columns of the similarity matrix are numbers of the clusters, numerical values in the similarity matrix are the similarities between the time interval KPI sets of the clusters, and the similarity matrix is a diagonal matrix.

TABLE 3

| | a | b | c | d |
|---|---|---|---|---|
| a | 1 | 0.32 | 0.96 | 0.46 |
| b | 0.32 | 1 | 0.55 | 0.96 |
| c | 0.96 | 0.55 | 1 | 0.23 |
| d | 0.46 | 0.96 | 0.23 | 1 |

In Step S11, the similarity between the time interval KPI sets of various clusters is sequenced according to a numerical value, then the numerical value of the similarity is fit into a smooth line, and a boundary line of the similarity between the time interval KPI sets of various clusters is obtained according to an inflection point method.

In Step S12, the numerical value of the similarity greater than the inflection point in the similarity matrix is replaced by 1, and the numerical value of the similarity less than the inflection point is replaced by 0, as shown in Table 4.

TABLE 4

| | a | b | c | d |
|---|---|---|---|---|
| a | 1 | 0 | 1 | 0 |
| b | 0 | 1 | 0 | 1 |
| c | 1 | 0 | 1 | 0 |
| d | 0 | 1 | 0 | 1 |

In Step S13, adjacent clusters with the similarity of 1 in the similarity matrix obtained in the Step S12 are marked as a same similar group, and the number of clusters in each similar group is counted.

In Step S14, a total time interval of one group with a largest number of clusters in the similar group is calculated as a width of a sliding window.

The total time interval is set as a width of a sliding window, the window is used for segmenting the log KPI curve into several segments, and the time width of each segment covers the similar group with the maximum time length obtained in the Step S12. By scanning the log KPI curve through the sliding window, consecutively appearing clusters can be quickly segmented into one window, and then can be quickly clustered into a same waveform category, so that a calculation amount is reduced, and the wavebands of the log KPI curve can be integrally classified, thus reducing the probability of knowledge omission.

The above NCC (normalized cross correlation) algorithm is defined as:

$${N}_{h} = \frac{{\sum }_{t = 1}^{n - h} {x}_{t} * {y}_{t + h}}{\vert {\sum }_{t = 1}^{n - h} {x}_{t} \vert \vert {\sum }_{t = 1}^{n - h} {y}_{t + h} \vert}$$

wherein, xₜ is a background waveform, yₜ₊ₕ is a template waveform, a value of the NCC is between −1 and 1, −1 represents that waveforms before and after transformation are opposite, 0 represents that the two waveforms are orthogonal, and 1 represents that the two waveforms are exactly the same. The NCC only describes a macroscopic similarity of the two waveforms, which has nothing to do with a waveform amplitude and energy attenuation.

In Step S15, each log KPI curve obtained in the Step R5 is segmented into several window segments of the log KPI curve with a time sequence width being a total time interval according to the sliding window obtained in the Step S14 first, and the window segment of the log KPI curve is segmented into a data set M′ᵢ of an i segment of the log KPI curve with a time sequence width of 1 minute according to the segmenting method in the Step H1, wherein each segment is one waveband.

The similarity between each fundamental wave obtained in the Step H3 and each waveband in each window of each log KPI curve is calculated by the NCC algorithm one by one to obtain NCCM′_{i-Jk}, the similarity is sequenced from large to small, in the waveband with the waveform similarity ranking as the top 95%, a minimum value of the waveform similarity is taken as a grouping boundary line B′k of the group, the grouping boundary line of each group is taken as a reference, whether a data set M′ i of each segment of the log KPI curve belongs to the group is judged, a data set M′ᵢ of one segment of the log KPI curve belonging to a plurality of groups at the same time is sequenced according to a classification score Q′, and the data set M′ᵢ of the log KPI curve is grouped into a group with a minimum classification score Q′ to form the label chain composed of the fundamental wave labels as shown in FIG. 2, and mode waveforms of different KPI curves are obtained, which are called the KPI curve code pattern rearrangement table, wherein Q′=((1−NCCM′_{i-J k})/(1−B′ₖ))².

Label information obtained after processing by the Step S15 contains all information of all wavebands, comprising two representations of waveband and waveform, a waveband label is a fundamental wave type, and a waveform label comprises a business label and a period label.

Therefore, every time the window slides on the log KPI curve, one waveband chain is obtained, all waveband chains are of the same length, and classification labels of the wavebands are different in sequencing. In the embodiment, curve characteristics of the log KPI curves of different monitoring indicators with correlation are converted into sequencing characteristics of a label chain, and due to the correlation, the log KPI curves have different amplitudes but similar periods and similar fluctuating paces, which is label arrangement, so that a large number of correlated KPI curves may be unified into label chains with consistent standards.

In Step S16, different KPI curve code pattern rearrangement tables are put into one dimension by time dimension unification to obtain a KPI curve code pattern rearrangement association table.

If different log KPI curves use a same log KPI curve business label, there may be a causal relationship, wherein the probability of the aperiodic log KPI curve is higher than that of the periodic log KPI curve.

If different log KPI curves have a same log KPI curve segment code patter fundamental wave label in an adjacent time period, there may be a causal relationship, wherein the possibility of the log KPI curve repeated for more times is higher.

After all label chains are arranged according to the time dimension, a causal relationship between different label chains occurring at different time may be discovered based on a sequence mining algorithm SPADE or GSP. If two events always occur in a pair, the two events are considered to be correlated, and if one event always occurs before the other event, the two events are considered to have a causal relationship, wherein the former is cause and the latter is effect, which is conductive to supplementing an expert's knowledge system for fault identification in the system, and discovering the correlation of the monitoring indicators not discovered before, so that new early warning control relationship and regulation threshold may be established based on the correlation between newly discovered monitoring indicators in operation, thus improving system stability of each monitored object in the same system.

### Embodiment 6

A KPI generation method based on log keyword clustering comprises the following steps.

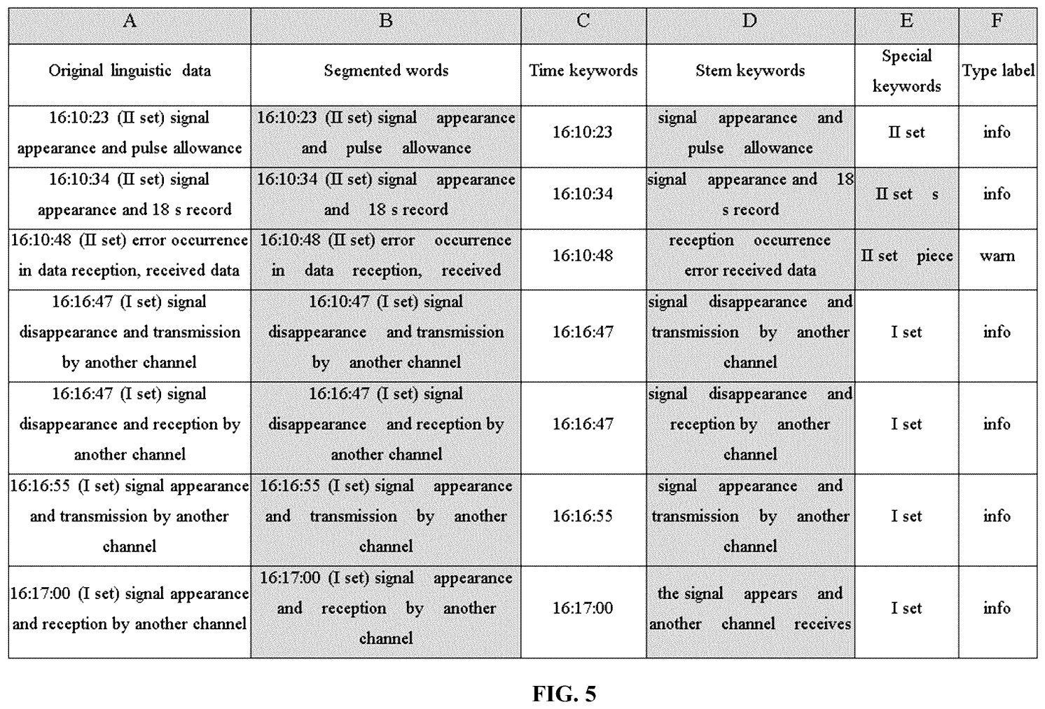

In Step B1, fault logs obtained by industrial control devices in a same industrial control system network of a power station based on monitoring indicators are collected, segmented words of linguistic data appearing in the fault logs are counted, and high-frequency words are counted, as shown in FIG. 5, wherein verbs, nouns and proper nouns are extracted as log keywords (business explicit relationship).

The counting of the segmented words comprises the following steps.

In F1, a training sentence set composed of training sentences is set, linguistic data are extracted from the fault logs to constitute a sentence pair to be processed with each training sentence respectively, and work segmentation is carried out on sentences in a sentence pair respectively based on a pre-built corpus, wherein the pre-built corpus comprises an industry corpus and a general corpus.

In F2, each characteristic word of the sentence subjected to word segmentation is converted into a word vector, a similarity of each sentence pair is respectively calculated by a cosine similarity, and the linguistic data are deleted when the similarity is lower than a threshold, for example, the threshold is set to be 0.9.

The Steps F1 and F2 are used for selecting a sentence with grammatical and semantic structures used for reference, behavior record and state description from the fault logs, according to general grammars of the fault logs in the industrial control system, such as: [what is an object], [the object completes a certain task], [in a certain state] and [how much is a certain item], these sentences have less ambiguity in description structure, which is conducive to removing an error log from the fault logs and keeping an industrial record log.

The word segmentation is carried out on the linguistic data by using a jieba.cut function during word segmentation, and the cut function is defined as follows:
def cut (sentence, cut_all=False, HMM=True)

wherein, sentence is a sentence sample to be subjected to word segmentation; cut_all is a mode of word segmentation, jieba word segmentation has two modes: a full mode and an accurate mode, which are selected by true and false respectively, and a default mode is false, that is, the accurate mode; and HMM is a hidden Markov chain, which is used in a theoretical model of word segmentation and turned on by default.

In F3, word segmentation is carried out on the remaining linguistic data in the Step F2, a segmented word queue composed of a plurality of characteristic words is generated, and part-of-speech tagging is carried out on the plurality of characteristic words to obtain a part-of-speech queue of the linguistic data.

During part-of-speech tagging, input words are returned to a category code by using a jieba.posseg.cut function. Qingyue Yang recorded use steps of the jieba.posseg.cut function and a part-of-speech classification table in “a part-of-speech table of jieba word segmentation”.

In F4, when the part-of-speech queue contains a plurality of special characteristic words corresponding to special parts of speech, obtaining a boundary and a category of a named entity from the plurality of special characteristic words by a named entity recognition model, and updating the parts of speech of the special characteristic words in the part-of-speech queue into the boundary and the category of the named entity to obtain an updated part-of-speech queue.

The special parts of speech comprise: numerals and time words. In an application scenario of the embodiment, only numerical values and time are prone to inaccurate recognition by part-of-speech classification.

A named entity recognition model may recognize a named referent from the linguistic data to be processed. In a narrow sense, four kinds of named entities: personal names, place names, organization names and proper nouns are recognized. There are usually two parts: (1) entity boundary recognition; and (2) entity category (personal names, place names, organization names or others) determination. There are many methods for named entity recognition, such as a rule-based method, a characteristic template-based method and a neural network-based method, and the named entity recognition model may be established based on the above methods.

For example, the named entity recognition model (CRF) carries out entity tagging on the sentence “I came to Taojia Village”, and a result after correct tagging is: I/O come/O to/O Tao/B jia/M village/E (wherein O represents that a current word is not a geographical named entity, and B, M and E represent that current words are a head part, an inner part and a tail part of the geographical named entity respectively). When a linear chain CRF is used to solve the problem, (O, O, O, B, M, E) is a tagging sequence, and (O, O, O, B, M, E) is also a tagging choice.

In F5, the remaining linguistic data are classified according to the tagging of the remaining linguistic data in the F4, a frequency of occurrence of each part-of-speech queue is counted, the part-of-speech queue is sequenced in a descending order, part-of-speech combinations ranking as the top 10% are selected, and frequencies of occurrence of verbs and nouns in each part-of-speech queue are counted.

In F6: each part-of-speech queue is sequenced in a descending order according to the frequencies of occurrence of verbs and nouns respectively, top two part-of-speech queue sets are sequentially selected from the above two sequences according to a sequencing threshold, and linguistic data corresponding to an intersection of the two part-of-speech queue sets are extracted to establish a true training set. In the embodiment, verbs ranking as the top 10% and nouns ranking as the top 5% are selected.

In F7, a segmented word queue with a part-of-speech tag combination of [n,v,n] is selected from the linguistic data of the true training set, and first and second segmented words with a part-of-speech of noun or proper noun are extracted from the segmented word queue as a first event and a second event respectively to form an event tuple.

In F8, an event association rule of the event tuple is discovered by a Snowball algorithm, and an associated event group in the event tuple is discovered according to the event association rule.

In Step C1, a queue containing an event in the fault event relation table in the event tuple is matched by the existing fault event relation table, and a template is generated, wherein a format of the template is in a quintuple form, which respectively comprises <left>, a type of an event 1, <middle>, a type of an event 2 and <right>; len is an arbitrary set length, <left> is a vector representation of len words on the left of the event 1, <middle> is a vector representation of words between the event 1 and the event 2, and <right> is a vector representation of len words on the right of the event.

In Step C2, the generated templates are clustered, templates with similarities greater than a threshold of 0.7 are clustered into one class, a new template is generated by an average method, and the template is added into a rule base for storing the templates, wherein, according to the Step C2, the format of the template is recorded as P=(\vec{L}, E₁, \vec{M}, E₂, \vec{R}), E₁ and E₂ respectively represent the type of the event 1 and the type of the event 2 of the template P, \vec{L} represents a vector representation of a length of three words on the left of E₁, \vec{M} represents a vector representation of words between E₁ and E₂, and \vec{R} represents a vector representation of a length of three words on the right of E₂, and according to the calculation of a similarity between the templates, a template 1: P₁=(\vec{L}₁, E₁, \vec{M}₁, E₂, \vec{R}₁) and a template 2: P₂=(\vec{L}₂, E₁′, \vec{M}₂, E₂′, \vec{R}₂) are obtained, when the condition that E₁=E′₁&&E₂=E′₂ is met, which means that the condition that a type E₁ of an event 1 of the template P₁ is the same as a type E′₁ of an event 1 of the template P₂ and a type E₂ of an event 2 of the template P₁ is the same as a type E′₂ of an event 2 of the template P₂ is met, a similarity between the template P₁ and the template P₂ is calculated by μ₁\vec{L₁}\vec{L₂}+μ₂\vec{M₁}\vec{M₂}+μ₃\vec{R₁}\vec{R₂}, μ₁, μ₂ and μ₃ are weights, and because \vec{M₁}\vec{M₂} has a great influence on a calculation result of the similarity between the templates, μ₂>μ₁>μ₃ is set; and when the condition E₁=E′₁&&E₂=E′₂ is not met, the similarity between the template P₁ and the template P₂ is recorded as 0.

The average method is to average the vectors of the templates in the same category to generate the new template, which may refer to “Snowball Algorithm for Relation Extraction-Programmer's Camp” reported in “https://www.pianshen.com/article/61161224295/”.

In Step C3, a similarity between a template of the event tuple obtained in the Step C1 and a template in the rule base is calculated one by one, a template with a similarity less than the threshold of 0.7 is discarded, and an event in a template with a similarity greater than the threshold of 0.7 is added into the log key event relation table to replace the fault event relation table.

In Step C4, the Steps C1 to C3 are repeated until no template needs to be discarded after processing in the Step C3, which means that no new event tuple or rule is capable of being discovered.

In Step C5, the part-of-speech queue obtained in the Step F4 is processed according to the Step F7 to obtain the true event tuple, the Steps C1 to C3 are repeated to obtain the log key event relation table of the true event tuple until convergence of the Step C3, and a template with a similarity less than a threshold of 0.95 is discarded in the Step C3.

In Step C6, each event in the log key event relation table is taken as a keyword, a frequency cᵢ of each keyword is counted, and then the keyword is sequenced in a descending order, wherein i represents a sequence number of the keyword.

In Step C7, In(cᵢ) corresponding to each keyword is calculated, the corresponding keyword is deleted if In(cᵢ) is lower than a boundary, and reserved keywords are taken as the keywords, wherein the boundary is a 3-sigma lower limit of all In(cᵢ). In this step, the calculation of In(cᵢ) is conductive to better distinguishing data with small differences to expand the difference between the data.

In Step B2, the found keywords are clustered, and a same cluster is marked to obtain a mapping relation B2 (business implicit relationship) of the log key event labels.

A frequency of occurrence of each keyword per minute is taken as a monitoring indicator to establish the KPI curve of each keyword, and the KPI curve of each keyword is smoothed by a Gaussian kernel. A pairwise similarity of the KPI curve of each keyword is calculated by the NCC algorithm, the similarity is expanded to form a diagonal similarity matrix, and the similarity is filled into the similarity matrix, wherein sequence numbers of rows and columns in the matrix are serial numbers of the KPI curves of the keywords, a number of rows and a number of columns in the similarity matrix are numbers of the KPI curves of the keywords, and a numerical value in the similarity matrix is the similarity between the KPI curve of each keyword.

Different cluster categories are output according to the similarity matrix above by a spectral clustering algorithm, and the different cluster categories are marked with different log key event labels; and a mapping relationship (business implicit relationship) of the log key event labels is obtained, as shown in the last column in FIG. 5.

A classification method of spectral clustering is introduced in “https://zhuanlan.zhihu.com/p/29849122”.

In Step B4, frequencies of occurrence of the same type of log key event labels in the same time period are merged and counted to obtain a log histogram of each log key event label, and the log histogram is smoothed by the Gaussian kernel to obtain each log KPI curve, as shown in FIG. 4.

The log KPI curve obtained in the Step B4 is preprocessed according to the following steps.

In Step K1, classification and labeling are carried out according to the periodicity of the log KPI curve.

Each log KPI curve is periodically verified and checked, and the log KPI curve is labeled according to a periodic difference of the KPI curve, which is called a log KPI curve period label.

The periodic verification and check comprise the following steps.

In Z01, a spectrum intensity map of the log KPI curve is extracted by Fourier transform.

In Z02, a highest point of a vibration amplitude is extracted to calculate a corresponding period, which is a to-be-detected period.

In Z03, a hypothetical period is set, which is an expected period, when a length of the to-be-detected period is within a range of 95% to 105% of the expected period, relevant intensity detection is carried out on the to-be-detected period, and when a spectrum intensity is sufficient, the to-be-detected period is regarded as a period meeting requirements.

In Step K2, classification and labeling are carried out according to the similarity of the log KPI curve.

In Z04, a pairwise similarity of each log KPI curve is calculated by the NCC algorithm, the similarity is expanded to form a diagonal similarity matrix, and the similarity is filled into the similarity matrix, wherein sequence numbers of rows and columns in the matrix are serial numbers of the log KPI curves, and a number of rows and a number of columns in the similarity matrix are numbers of the log KPI curves.

In Z05, different cluster categories are output according to the similarity matrix above by a spectral clustering algorithm, and the different cluster categories are marked with different log KPI curve labels, which are called KPI curve business labels.

A classification method of spectral clustering is introduced in “https://zhuanlan.zhihu.com/p/29849122”.

### Embodiment 7

A method for marking characteristics of a waveband based on the log KPI curve obtained in Embodiment 6 comprises the following steps.

In Step H1, a data point set of each minute in all log KPI curves is extracted into a same curve set L, and the curve set Lis segmented into data sets Mᵢ of several segments of the log KPI curve with a time width of s, wherein i is a segment sequence number.

In Step H2, an Euclidean distance between data sets of various segments is calculated according to an attribute of the data set of each segment of the log KPI curve by a dbscan algorithm, and a data set of an i segment of the log KPI curve is clustered to obtain k cluster categories and abnormal items, wherein each cluster is data sets of one group, and the data sets of each group contain the data set Fⱼ of the j segment of the log KPI curve.

In Step H3, the arithmetic mean value ΣFⱼ/j of the data set of the j segment of the log KPI curve in the data sets of each group is calculated as the fundamental wave of the group.

In Step H4, a waveform similarity between a data set Fⱼ of each segment of the log KPI curve in the data sets of each group and the fundamental wave is calculated by the NCC algorithm, the waveform similarity is sequenced from large to small, and in the data set Fⱼ of the log KPI curve with the waveform similarity ranking as the top 95%, a minimum value of the waveform similarity is taken as a grouping boundary line Bₖ of the group.

In Step H5, a waveform similarity NCC_{Mi-Jk} between the data set Mᵢ of each segment of the log KPI curve and the fundamental wave of each group is calculated by the NCC algorithm, whether the data set of each segment of the log KPI curve belongs to the group is judged by taking the grouping boundary line of each group as a reference, a data set of one segment of the log KPI curve belonging to a plurality of groups at the same time is sequenced according to a classification score Q, and the data set Mᵢ of the log KPI curve is grouped into a group with a minimum classification score Q to obtain grouping information of the data set of each segment of the log KPI curve, wherein Q=((1−NCC_{Mi-J k})/(1−Bₖ))².

The larger the NCC_{Mi-Jk}, the smaller the Q, which indicates that the Mᵢ is more similar to a cluster category k. When the similarity NCC_{Mi-Jk} between the data set Mᵢ of the log KPI curve and different cluster categories is the same, the smaller the Bₖ, the higher the similarity NCC_{M i-Jk} between the cluster category Mᵢ and the cluster category k in waveform similarity sequencing of the cluster categories. The possibility of the data set Mᵢ of the log KPI curve in candidate clusters may be calculated through this formula, thus calculating the most likely cluster category.

In Step G2, a time stamp of a data set of each segment of the log KPI curve classified into different groups is extracted to obtain a time stamp list of each group.

Subsequent steps are similar to those in Embodiment 1.

In Step S8, shift subtraction is carried out on the time stamp list of each group, which refers to subtracting a starting time stamp of the next item from a starting time stamp of the current item in each time stamp list to obtain an event trigger interval list.

An event trigger interval is a time interval between data sets of two adjacent segments of the log KPI curve in the data sets of each group.

In Step S9, event trigger intervals of each cluster are merged into a time interval KPI set, and a similarity between the time interval KPI sets of various clusters is calculated according to NCC. If the time interval KPI sets of different clusters are similar, the waveforms of the clusters are similar in a total time width.

In Step S10, the similarity between the time interval KPI sets of various clusters obtained in the Step S9 is expanded to form a similarity matrix. As shown in Table 5, a to d are sequence numbers of the clusters, a number of rows and a number of columns of the similarity matrix are numbers of the clusters, numerical values in the similarity matrix are the similarities between the time interval KPI sets of the clusters, and the similarity matrix is a diagonal matrix. Table 5

In Step S11, the similarity between the time interval KPI sets of various clusters is sequenced according to a numerical value, then the numerical value of the similarity is fit into a smooth line, and a boundary line of the similarity between the time interval KPI sets of various clusters is obtained according to an inflection point method.

In Step S12, the numerical value of the similarity greater than the inflection point in the similarity matrix is replaced by 1, and the numerical value of the similarity less than the inflection point is replaced by 0, as shown in Table 6.

TABLE 6

| | a | b | c | d |
|---|---|---|---|---|
| a | 1 | 0 | 1 | 0 |
| b | 0 | 1 | 0 | 1 |
| c | 1 | 0 | 1 | 0 |
| d | 0 | 1 | 0 | 1 |

In Step S13, adjacent clusters with the similarity of 1 in the similarity matrix obtained in the Step S12 are marked as a same similar group, and the number of clusters in each similar group is counted.

In Step S14, a total time interval of one group with a largest number of clusters in the similar group is calculated as a width of a sliding window.

The total time interval is set as a width of a sliding window, the window is used for segmenting the log KPI curve into several segments, and the time width of each segment covers the similar group with the maximum time length obtained in the Step S12. By scanning the log KPI curve through the sliding window, consecutively appearing clusters can be quickly segmented into one window, and then can be quickly clustered into a same waveform category, so that a calculation amount is reduced, and the wavebands of the log KPI curve can be integrally classified, thus reducing the probability of knowledge omission.

The above NCC (normalized cross correlation) algorithm is defined as:

$${N}_{h} = \frac{{\sum }_{t = 1}^{n - h} {x}_{t} * {y}_{t + h}}{\vert {\sum }_{t = 1}^{n - h} {x}_{t} \vert \vert {\sum }_{t = 1}^{n - h} {y}_{t + h} \vert}$$

wherein, xₜ is a background waveform, yₜ₊ₕ is a template waveform, a value of the NCC is between −1 and 1, −1 represents that waveforms before and after transformation are opposite, 0 represents that the two waveforms are orthogonal, and 1 represents that the two waveforms are exactly the same. The NCC only describes a macroscopic similarity of the two waveforms, which has nothing to do with a waveform amplitude and energy attenuation.

In Step S15, each log KPI curve smoothed by the Gaussian kernel in the Step B4 is segmented into several window segments of the log KPI curve with a time sequence width being a total time interval according to the sliding window obtained in the Step S14 first, and the window segment of the log KPI curve is segmented into a data set M′ᵢ of an i segment of the log KPI curve with a time sequence width of 1 minute according to the segmenting method in the Step A1, wherein each segment is one waveband.

The similarity between each fundamental wave obtained in the Step H3 and each waveband in each window of each log KPI curve is calculated by the NCC algorithm one by one to obtain NCCM′_{i-Jk}, the similarity is sequenced from large to small, in the waveband with the waveform similarity ranking as the top 95%, a minimum value of the waveform similarity is taken as a grouping boundary line B′ₖ of the group, the grouping boundary line of each group is taken as a reference, whether a data set M′ᵢ of each segment of the log KPI curve belongs to the group is judged, a data set M′ᵢ of one segment of the log KPI curve belonging to a plurality of groups at the same time is sequenced according to a classification score Q′, and the data set Mᵢ of the log KPI curve is grouped into a group with a minimum classification score Q′ to form the label chain composed of the fundamental wave labels as shown in FIG. 2, and mode waveforms of different KPI curves are obtained, which are called the KPI curve code pattern rearrangement table, wherein Q′=((1−NCCM′_{i-Jk})/(1−B′ₖ))².

Label information obtained after processing by the Step S15 contains all information of all wavebands, comprising two representations of waveband and waveform, a waveband label is a fundamental wave type, and a waveform label comprises a business label and a period label.

Therefore, every time the window slides on the log KPI curve, one waveband chain is obtained, all waveband chains are of the same length, and classification labels of the wavebands are different in sequencing. In the embodiment, curve characteristics of the log KPI curves of different monitoring indicators with correlation are converted into sequencing characteristics of a label chain, and due to the correlation, the log KPI curves have different amplitudes but similar periods and similar fluctuating paces, which is label arrangement, so that a large number of correlated KPI curves may be unified into label chains with consistent standards.

In Step S16, different KPI curve code pattern rearrangement tables are put into one dimension by time dimension unification to obtain a KPI curve code pattern rearrangement association table.

If different log KPI curves use a same log KPI curve business label, there may be a causal relationship, wherein the probability of the aperiodic log KPI curve is higher than that of the periodic log KPI curve.

If different log KPI curves have a same log KPI curve segment code patter fundamental wave label in an adjacent time period, there may be a causal relationship, wherein the possibility of the log KPI curve repeated for more times is higher.

After all label chains are arranged according to the time dimension, a causal relationship between different label chains occurring at different time may be discovered based on a sequence mining algorithm SPADE or GSP. If two events always occur in a pair, the two events are considered to be correlated, and if one event always occurs before the other event, the two events are considered to have a causal relationship, wherein the former is cause and the latter is effect, which is conductive to supplementing an expert's knowledge system for fault identification in the system, and discovering the correlation of the monitoring indicators not discovered before, so that new early warning control relationship and regulation threshold may be established based on the correlation between newly discovered monitoring indicators in operation, thus improving system stability of each monitored object in the same system.

What is claimed is:

1. A KPI curve data processing method, comprising the following steps of:
Step 1: establishing a waveform according to a relationship between historical data and time of monitoring indicators in a same system to obtain a KPI curve of at least one monitoring indicator, wherein each monitoring indicator is one attribute of a data point of the KPI curve, and the same system refers to a material production process, an energy production process or a control system consisting of monitored objects with direct or indirect material supply relationship, electric energy transfer relationship, thermal energy transfer relationship, mechanical energy transfer relationship, magnetic field transfer relationship, energy conversion relationship or signal control relationship; and the monitoring indicators are physical parameters acquired by sensors on the monitored objects;
Step 2: segmenting the KPI curve into several wavebands with a time sequence width of 1 s, clustering the wavebands to form a plurality of clusters according to a non-time dimension of the wavebands, and extracting a fundamental wave of each cluster;
Step 3: comparing a similarity between data of each waveband and the fundamental wave of each cluster in the Step 2, discovering a grouping boundary line of each cluster, and grouping the data of each waveband of each cluster;
Step 4: extracting a time stamp of each cluster classified into different groups to obtain a time stamp list of each group;
Step 5: carrying out shift subtraction on the time stamp list of each group, which refers to subtracting a starting time stamp of the next item from a starting time stamp of the current item in each time stamp list to obtain an event trigger interval list;
Step 6: merging event trigger intervals of each cluster into a time interval KPI set, and calculating a similarity between the time interval KPI sets of various clusters according to NCC;
Step 7: expanding the similarity between the time interval KPI sets of various clusters obtained in the Step 4 to form a similarity matrix;
Step 8: sequencing the similarity between the time interval KPI sets of various clusters according to a numerical value, then fitting the numerical value of the similarity into a smooth line, and obtaining a boundary line of the similarity between the time interval KPI sets of various clusters according to an inflection point method;
Step 9: marking adjacent clusters with numerical values greater than an inflection point in the similarity matrix as a same similar group, and counting a number of clusters in each similar group; and
Step 10: calculating a total time interval of one group with a largest number of clusters in the similar groups as a width of a sliding window.

2. The KPI curve data processing method according to claim 1, wherein, in the Step 2, the step of extracting the fundamental wave of each cluster comprises: calculating an arithmetic mean value ΣFⱼ/j of a data set of a j segment of the KPI curve in data sets of each group as the fundamental wave of the group.

3. The KPI curve data processing method according to claim 2, wherein, the Step 2 comprises the following steps of:
Step J2: extracting a data point set of each time sequence in all KPI curves processed in the Step 1 into a same curve set L, setting a stride sliding window, with a step length of s, wherein s=1 second, and segmenting the curve set L into data sets Mᵢ of several segments of the KPI curve with a time width of s according to a window width, wherein i is a segment sequence number;
Step J3: calculating an Euclidean distance between data sets of various segments according to an attribute of the data set of each segment of the KPI curve by a dbscan algorithm, and clustering a data set of an i segment of the KPI curve to obtain k cluster categories and abnormal items, wherein each cluster is data sets of one group, and the data sets of each group contain the data set Fⱼ of the j segment of the KPI curve; and
Step J4: calculating the arithmetic mean value ΣFⱼ/j of the data set of the j segment of the KPI curve in the data sets of each group as the fundamental wave of the group;
the Step 3 comprises the following steps of:
Step J5: calculating a waveform similarity between the data set Fⱼ of each segment of the KPI curve in the data sets of each group and the fundamental wave by the NCC algorithm, sequencing the waveform similarity from large to small, and in the data set Fⱼ of the KPI curve with the waveform similarity ranking as the top 95%, taking a minimum value of the waveform similarity as a grouping boundary line Bₖ of the group; and
Step J6: calculating a waveform similarity NCC_{Mi-Jk} between the data set Mᵢ of each segment of the KPI curve and the fundamental wave of each group by the NCC algorithm, judging whether the data set of each segment of the KPI curve belongs to the group by taking the grouping boundary line of each group as a reference, sequencing a data set of one segment of the KPI curve belonging to a plurality of groups at the same time according to a classification score Q, and grouping the data set Mᵢ of the KPI curve into a group with a minimum classification score Q to obtain grouping information of the data set of each segment of the KPI curve, wherein Q=((1−NCC_{Mi-Jk})/(1−Bₖ))².

4. The KPI curve data processing method according to claim 1, wherein the Step 9 is replaced by: replacing the numerical value of the similarity greater than the inflection point in the similarity matrix by 1, and replacing the numerical value of the similarity less than the inflection point by 0; and marking adjacent clusters with the similarity of 1 in the updated similarity matrix as the same similar group, and counting the number of clusters in each similar group.

5. The KPI curve data processing method according to claim 1, wherein the monitoring indicators comprise physical parameters acquired by sensors on a generator and a monitored object with a material supply relationship, an electric energy transfer relationship, a thermal energy transfer relationship, a mechanical energy transfer relationship, a magnetic field transfer relationship, an energy conversion relationship or a signal control relationship with the generator.

6. The KPI curve data processing method according to claim 5, wherein the physical parameters comprise a rotation speed, a real-time power generation capacity, a voltage and an excitation current of the generator, a vibration signal and a displacement signal of a generator shell, temperatures of a connection terminal of each electric transmission and transformation line electrically connected with a generator output cable and a crank, and a temperature and a humidity in an electric cabinet.

7. The KPI curve data processing method according to claim 1, wherein the KPI curve data processing method is further used for marking characteristics of the waveband of the KPI curve, and, after the Step 10, further comprises the following steps of:
Step 11: segmenting each KPI curve processed in the Step 1 into several window segments of the KPI curve with a time sequence width being a total time interval according to a preset sliding window first, and segmenting the window segment of the KPI curve into a data set M′ᵢ of an i segment of the KPI curve with a time sequence width of 1 s according to the segmenting method in the Step 2, wherein each segment is one waveband; and
comparing a similarity between each fundamental wave obtained in the Step 2 and each waveband in each window of each KPI curve one by one, sequencing the waveband according to the similarity from large to small, discovering a grouping boundary line according to the sequence, grouping the wavebands to form a label chain composed of fundamental wave labels, and obtaining mode waveforms of different KPI curves, which are called a KPI curve code pattern rearrangement table; and
Step 12: putting different KPI curve code pattern rearrangement tables into one dimension by time dimension unification to obtain a KPI curve code pattern rearrangement association table.

8. The KPI curve data processing method according to claim 7, wherein the KPI curve data processing method is further used for marking characteristics of a waveband of a log KPI curve, and the log KPI curve is generated by the following steps of:
Step F1: setting a training sentence set composed of training sentences, obtaining, by industrial control devices in a same industrial control system, fault logs based on the monitoring indicators, respectively constituting linguistic data in the fault logs and each training sentence into a sentence pair to be processed, calculating a similarity, and deleting linguistic data with a similarity lower than a first threshold;
Step F2: carrying out word segmentation on the remaining linguistic data in the Step F1, generating a segmented word queue composed of a plurality of characteristic words, and carrying out part-of-speech tagging on the plurality of characteristic words to obtain a part-of-speech queue of the linguistic data;
Step F3: when the part-of-speech queue contains a plurality of special characteristic words corresponding to special parts of speech, obtaining a boundary and a category of a named entity from the plurality of special characteristic words by a named entity recognition model, and updating the parts of speech of the special characteristic words in the part-of-speech queue into the boundary and the category of the named entity to obtain an updated part-of-speech queue, wherein the special parts of speech comprise numerals and temporal words;
Step F4: classifying the remaining linguistic data according to the tagging of the remaining linguistic data in the Step F3, counting a frequency of occurrence of each part-of-speech queue, sequencing the part-of-speech queue in a descending order, selecting a part-of-speech queue with a sequence greater than a second threshold, counting frequencies of occurrence of verbs and nouns in each part-of-speech queue, sequencing the part-of-speech queue in a descending order, sequentially selecting top two part-of-speech queue sets from the above two sequences according to a sequencing threshold, and extracting linguistic data corresponding to an intersection of the two part-of-speech queue sets to establish a true training set;
Step F5: selecting a segmented word queue with a part-of-speech tag combination of [n,v,n] from the linguistic data of the true training set, wherein n represents a part-of-speech of noun and v represents a part-of-speech of verb, and extracting first and second segmented words with a part-of-speech of noun or proper noun from the segmented word queue as a first event and a second event respectively to form an event tuple;
Step F6: based on an existing fault event relation table, discovering an event association rule of the event tuple by a Snowball algorithm, and discovering an associated event group in the event tuple according to the event association rule, which refers to generating a log key event relation table;
Step F7: repeating the Step F6 based on the log key event relation table until convergence; and
Step F8: taking each event relationship generated in the Step F7 as a log key event label to mark the fault logs, taking a frequency of occurrence of each log key event label per minute as a monitoring indicator to establish each log KPI curve, and smoothing each log KPI curve by a Gaussian kernel;
the KPI curve in the Step 1 to the Step 12 is replaced by the log KPI curve;
the Step 1 to the Step 3 are replaced by:
Step G1: merging a data point set of each minute in all log KPI curves, then segmenting the merged product into several wavebands with a time width of s minutes, clustering the wavebands to form a plurality of clusters according to a non-time dimension of the wavebands, extracting a fundamental wave of each cluster, comparing a similarity between data of each waveband and the fundamental wave of each cluster, discovering a grouping boundary line of each cluster, and grouping the data of each waveband of each cluster; and
Step G2: extracting a time stamp of a data set of each segment of the log KPI curve classified into different groups to obtain a time stamp list of each group;
the Step 11 is replaced by: segmenting each log KPI curve into several window segments of the log KPI curve with a time sequence width being a total time interval according to the sliding window obtained in the Step 10 first, and segmenting the window segment of the log KPI curve into a data set M′ᵢ of an i segment of the log KPI curve with a time sequence width of 1 minute according to the segmenting method in the Step G1, wherein each segment is one waveband; and
comparing a similarity between each fundamental wave obtained in the Step G1 and each waveband in each window of each log KPI curve one by one, sequencing the waveband according to the similarity from large to small, discovering a grouping boundary line according to the sequence, grouping the wavebands to form a label chain composed of fundamental wave labels, and obtaining mode waveforms of different KPI curves, which are called a KPI curve code pattern rearrangement table.

9. The method according to claim 8, wherein the Step F7 to the Step F8 are replaced by:
Step f7: then processing the part-of-speech queue obtained in the Step F3 according to the Step F5 to obtain the true event tuple, and repeating the Step F6 to obtain the log key event relation table of the true event tuple until convergence of the Step F6;
Step f8: taking each event in the log key event relation table as a keyword, counting a frequency cᵢ of each keyword, wherein i represents a sequence number of the keyword, combining In(cᵢ) corresponding to all keywords into a set, and when the In(cᵢ) is lower than a 3-sigma lower limit of the set, deleting corresponding keywords, and taking reserved keywords as the keywords;
Step f9: taking a frequency of occurrence of each keyword per minute as a monitoring indicator to establish a KPI curve of each keyword;
Step f10: calculating a pairwise similarity of the KPI curve of each keyword by the NCC algorithm, expanding the similarity to form a diagonal similarity matrix, and filling the similarity into the similarity matrix, wherein sequence numbers of rows and columns in the matrix are serial numbers of the KPI curves of the keywords, a number of rows and a number of columns in the similarity matrix are numbers of the KPI curves of the keywords, and a numerical value in the similarity matrix is the similarity between the KPI curve of each keyword;
Step f11: outputting different cluster categories according to the similarity matrix above by a spectral clustering algorithm, and marking the different cluster categories with different log key event labels; and
Step f12: merging and counting frequencies of occurrence of the same type of log key event labels in the same time period to obtain a log histogram of each log key event label, and smoothing the log histogram by the Gaussian kernel to obtain each log KPI curve.

10. The method according to claim 9, wherein, in the Step F1, the calculating the similarity comprises the following steps of:
respectively carrying out word segmentation on sentences in the sentence pair based on a pre-established corpus, wherein the pre-established corpus comprises an industry corpus and a general corpus; and
converting each characteristic word of the sentence subjected to word segmentation into a word vector, respectively calculating a similarity of each sentence pair by a cosine similarity, and deleting the linguistic data when the similarity is lower than the first threshold.

11. The method according to claim 9, wherein, between the Steps f9 and f10, the method further comprises the following step of: smoothing the KPI curve of each keyword by the Gaussian kernel.

12. The method according to claim 7, wherein the steps after segmenting the window segment of the KPI curve into the wavebands in the Step 11 comprise:
calculating the similarity between each fundamental wave obtained in the Step 2 and each waveband in each window of each KPI curve by the NCC algorithm one by one to obtain NCCM′ i-J k, sequencing the similarity from large to small, in the waveband with the waveform similarity ranking as the top 95%, taking a minimum value of the waveform similarity as a grouping boundary line B′k of the group, taking the grouping boundary line of each group as a reference, judging whether a data set M′i of each segment of the KPI curve belongs to the group, sequencing a data set M′i of one segment of the KPI curve belonging to a plurality of groups at the same time according to a classification score Q′, and grouping the data set Mi of the KPI curve into a group with a minimum classification score Q′ to form the label chain composed of the fundamental wave labels, and obtaining mode waveforms of different KPI curves, which are called the KPI curve code pattern rearrangement table, wherein Q′=((1−NCCM′ i−J k)/(1−B′ k))2.

13. The method according to claim 9, wherein the steps after segmenting the window segment of the KPI curve into the wavebands in the Step 11 comprise:
calculating the similarity between each fundamental wave obtained in the Step G1 and each waveband in each window of each log KPI curve by the NCC algorithm one by one to obtain NCCM′_{i-J k}, sequencing the similarity from large to small, in the waveband with the waveform similarity ranking as the top 95%, taking a minimum value of the waveform similarity as a grouping boundary line B′k of the group, taking the grouping boundary line of each group as a reference, judging whether a data set M′ᵢ of each segment of the log KPI curve belongs to the group, sequencing a data set M′ᵢ of one segment of the log KPI curve belonging to a plurality of groups at the same time according to a classification score Q′, and grouping the data set Mᵢ of the log KPI curve into a group with a minimum classification score Q′ to form the label chain composed of the fundamental wave labels, and obtaining mode waveforms of different KPI curves, which are called the KPI curve code pattern rearrangement table, wherein Q′=((1−NCCM′_{i-Jk})/(1−B′ₖ))².

14. The method according to claim 9, wherein, between the Step 1 and the Step J2 of claim 7, or after the Step F8 of claim 8, or after the Step f12 of claim 9, the method further comprises the following steps of:
Z01: extracting a spectrum intensity map of the KPI curve or the log KPI curve by Fourier transform;
Z02: extracting a highest point of a vibration amplitude to calculate a corresponding period, which is a to-be-detected period; and
Z03: setting a hypothetical period, which is an expected period, when a length of the to-be-detected period is within a range of 95% to 105% of the expected period, carrying out relevant intensity detection on the to-be-detected period, when a spectrum intensity is sufficient, regarding the to-be-detected period as a period meeting requirements, and labeling a filtered KPI curve or log KPI curve according to a periodic difference of the KPI curve or the log KPI curve, which is called a KPI curve or log KPI curve period label.

15. The method according to claim 14, wherein, after the Step Z03, the method further comprises the following steps of:
Z04: calculating a pairwise similarity of each KPI curve or each log KPI curve by the NCC algorithm, expanding the similarity to form a diagonal similarity matrix, and filling the similarity into the similarity matrix, wherein sequence numbers of rows and columns in the matrix are serial numbers of the KPI curves or the log KPI curves, and a number of rows and a number of columns in the similarity matrix are numbers of the KPI curves or the log KPI curves; and
Z05: marking the cluster categories with different KPI curve labels or log KPI curve labels by the spectral clustering algorithm according to the similarity matrix above, which are called KPI curve business labels.

16. The method according to claim 9, wherein the Step F6 comprises:
Step C1: matching a queue containing an event in the fault event relation table in the event tuple by the existing fault event relation table, and generating a template, wherein a format of the template is in a quintuple form, which respectively comprises <left>, a type of an event 1, <middle>, a type of an event 2 and <right>; len is an arbitrary set length, <left> is a vector representation of len words on the left of the event 1, <middle> is a vector representation of words between the event 1 and the event 2, and <right> is a vector representation of len words on the right of the event;
Step C2: clustering the generated templates, clustering templates with similarities greater than a third threshold into one class, generating a new template by an average method, and adding the template into a rule base for storing the templates, wherein, according to the Step C2, the format of the template is recorded as P=(\vec{L}, E₁, \vec{M}, E₂, \vec{R}), E₁ and E₂ respectively represent the type of the event 1 and the type of the event 2 of the template P, \vec{L} represents a vector representation of a length of three words on the left of E₁, \vec{M} represents a vector representation of words between E₁ and E₂, and R represents a vector representation of a length of three words on the right of E₂, and according to the calculation of a similarity between the templates, a template 1: P₁=(\vec{L}₁, E₁, \vec{M}₁, E₂, \vec{R}₁) and a template 2: P₂=(\vec{L}₂, E₁′, \vec{M}₂, E₂′, \vec{R}₂) are obtained, when the condition that E₁=E′₁&&E₂=E′₂ is met, which means that the condition that a type E₁ of an event 1 of the template P₁ is the same as a type E′₁ of an event 1 of the template P₂ and a type E₂ of an event 2 of the template P₁ is the same as a type E′₂ of an event 2 of the template P₂ is met, a similarity between the template P₁ and the template P₂ is calculated by μ₁\vec{L₁}\vec{L₂}+μ₂\vec{M₁}\vec{M₂}+μ₃\vec{R₁}\vec{R₂}, wherein μ₁, μ₂ and μ₃, are weights, and because \vec{M₁}\vec{M₂} has a great influence on a calculation result of the similarity between the templates, μ₂>μ₁>μ₃ is set; and when the condition E₁=E′₁&&E₂=E′₂ is not met, the similarity between the template P₁ and the template P₂ is recorded as 0;
Step C3: calculating a similarity between a template of the event tuple obtained in the Step C1 and a template in the rule base one by one, discarding a template with a similarity less than the third threshold, and adding an event in a template with a similarity greater than the third threshold into the log key event relation table to replace the fault event relation table; and
Step C4: repeating the Steps C1 to C3 until no template needs to be discarded after processing in the Step C3, which means that no new event tuple or rule is capable of being discovered.

17. The method according to claim 9, wherein the Step f7 is replaced by: then processing the part-of-speech queue obtained in the Step F3 according to the Step F5 to obtain the true event tuple, repeating the Steps C1 to C3 to obtain the log key event relation table of the true event tuple until convergence of the Step C3, and discarding a template with a similarity less than a fourth threshold in the Step C3.

18. The method according to claim 9, wherein the Step G1 comprises the following steps of:
Step H1: extracting a data point set of each minute in all log KPI curves into a same curve set L, and segmenting the curve set L into data sets Mᵢ of several segments of the log KPI curve with a time width of s, wherein i is a segment sequence number;
Step H2: calculating an Euclidean distance between data sets of various segments according to an attribute of the data set of each segment of the log KPI curve by a dbscan algorithm, and clustering a data set of an i segment of the log KPI curve to obtain k cluster categories and abnormal items, wherein each cluster is data sets of one group, and the data sets of each group contain the data set Fⱼ of the j segment of the log KPI curve; and
Step H3: calculating the arithmetic mean value ΣFⱼ/j of the data set of the j segment of the log KPI curve in the data sets of each group as the fundamental wave of the group;
Step H4: calculating a waveform similarity between a data set Fⱼ of each segment of the log KPI curve in the data sets of each group and the fundamental wave by the NCC algorithm, sequencing the waveform similarity from large to small, and in the data set Fⱼ of the log KPI curve with the waveform similarity ranking as the top 95%, taking a minimum value of the waveform similarity as a grouping boundary line Bₖ of the group; and
Step H5: calculating a waveform similarity NCC_{Mi-Jk} between the data set Mᵢ of each segment of the log KPI curve and the fundamental wave of each group by the NCC algorithm, judging whether the data set of each segment of the log KPI curve belongs to the group by taking the grouping boundary line of each group as a reference, sequencing a data set of one segment of the log KPI curve belonging to a plurality of groups at the same time according to a classification score Q, and grouping the data set Mᵢ of the log KPI curve into a group with a minimum classification score Q to obtain grouping information of the data set of each segment of the log KPI curve, wherein Q=((1−NCC_{Mi-Jk})/(1−Bₖ))².

19. The method according to claim 9, wherein after all label chains are arranged according to the time dimension, a causal relationship between different label chains occurring at different time is discovered based on a sequence mining algorithm SPADE or GSP.
